(19) United States
(12) Patent Application Publication
(10) Pub. No.: US 2024/0267919 A1
(43) Pub. Date: Aug. 8, 2024

(54) METHOD AND APPARATUS FOR PERFORMING SBFD BASED COMMUNICATION IN WIRELESS COMMUNICATION SYSTEMS

(71) Applicant: Samsung Electronics Co., Ltd., Gyeonggi-do (KR)

(72) Inventors: Jaeyeon SHIM, Gyeonggi-do (KR); Youngrok JANG, Gyeonggi-do (KR); Hyoungju JI, Gyeonggi-do (KR); Kyungjun CHOI, Gyeonggi-do (KR); Hyemin CHOE, Gyeonggi-do (KR)

(21) Appl. No.: 18/404,366

(22) Filed: Jan. 4, 2024

(30) Foreign Application Priority Data
Jan. 6, 2023 (KR) 10-2023-0002108

(51) Int. Cl. H04W 72/1273; H04L 1/00; H04W 72/0453; H04W 72/232

(52) U.S. Cl. CPC H04W 72/1273; H04L 1/0007; H04W 72/0453; H04W 72/232

(57) ABSTRACT

The disclosure relates to a 5G or 6G communication system for supporting a higher data transmission rate. Disclosed is a 5G or pre-5G communication system provided to support a higher data transmission rate than a 4G communication system such as LTE. A PDSCH scheduling method in a wireless communication system includes interpreting scheduling information with reference to information associated with an uplink subband, when a UE receives a PDSCH from a base station, by interpreting the size of a scheduled PRB and a bandwidth part size which are appropriate for full-duplex communication. A method of determining a PRG grid and a PRB bundling size which are appropriate for full-duplex communication when a UE receives a PDSCH from a base station includes receiving, from a BS, subband frequency information related to 95frequency domain resource allocation for an UL subband, receiving, from the BS, DC related to frequency domain resource allocation for a PDSCH, identifying a PRG including at least one PRB for the PDSCH based on the subband frequency information and the DCI, and receiving, from the BS, the PDSCH based on the PRG.

### CROSS-REFERENCE TO RELATED APPLICATION(S)

This application is based on and claims priority under 35 U.S.C. § 119 to Korean Patent Application No. 10-2023-0002108, filed on Jan. 6, 2023, in the Korean Intellectual Property Office, the disclosure of which is incorporated herein by reference in its entirety.

### BACKGROUND

### 1. Field

The disclosure relates generally to a wireless communication system, and more particularly, to a method of performing data channel transmission or reception with a user equipment (UE) that supports full-duplex communication in a wireless communication system.

### 2. Description of Related Art

Fifth generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmWave) bands including 28 GHz and 39 GHz. In addition, it has been considered to implement sixth generation (6G) mobile communication technologies (referred to as beyond 5G systems) in terahertz (THz) bands (for example, 95 GHz to 3 THz bands) to accomplish transmission rates fifty times faster than 5G mobile communication technologies and ultra-low latencies one-tenth of 5G mobile communication technologies.

When the development of 5G mobile communication technologies began, to support services and to satisfy performance requirements in connection with enhanced mobile broadband (eMBB), ultra reliable low latency communications (URLLC), and massive machine-type communications (mMTC), there has been ongoing standardization regarding beamforming and massive multi-input multi-output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Discussions persist regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There is also ongoing standardization in system architecture/service regarding a 5G service based architecture or service based interface for combining network functions virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks. Thus, it is anticipated that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

A wireless communication system is advancing to a broadband wireless communication system for providing high-speed and high-quality packet data services using communication standards, such as high-speed packet access (HSPA) of 3GPP, LTE {long-term evolution or evolved universal terrestrial radio access (E-UTRA)}, LTE-advanced (LTE-A), LTE-pro, high-rate packet data (HRPD) of 3GPP2, ultra-mobile broadband (UMB), IEEE 802.16e, and the like, as well as typical voice-based services.

As an example, an LTE system employs an orthogonal frequency division multiplexing (OFDM) scheme in the DL and employs a single carrier frequency division multiple access (SC-FDMA) scheme in a UL, which indicates a radio link through which a UE (or transmits data or control signals to a BS (eNode B), and the DL indicates a radio link through which the BS transmits data or control signals to the UE. The above multiple access scheme may separate data or control information of respective users by allocating and operating time-frequency resources for transmitting the data or control information for each user so as to avoid overlapping each other and to establish orthogonality.

Since a 5G communication system, which is a post-LTE communication system, must freely reflect various requirements of users, service providers, and the like, services satisfying various requirements must be supported. The services considered in the 5G communication system include eMBB communication, mMTC, URLLC, etc.

The eMBB aims at providing a data rate higher than that supported by existing LTE, LTE-A, or LTE-Pro. For example, in the 5G communication system, eMBB must provide a peak data rate of 20 Gbps in the DL and a peak data rate of 10 Gbps in the UL for a single BS. Furthermore, the 5G communication system must provide an increased user-perceived data rate to the UE, as well as the maximum data rate. To satisfy such requirements, transmission/reception technologies including a further enhanced MIMO transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IOT) in the 5G communication system. mMTC has requirements, such as support of connection of a large number of UEs in a cell, enhancement coverage of UEs, improved battery time, a reduction in the cost of a UE, and the like, to effectively provide the IoT. Since the IoT provides communication functions while being provided to various sensors and various devices, it must support many UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

The URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 milliseconds (ms), and also requires a packet error rate of 10-5 or less. Therefore, for the services supporting URLLC, a 5G system must provide a transmit time interval (TTI) shorter than those of other services, and also may require a design for assigning a large number of resources in a frequency band to secure reliability of a communication link.

The three 5G services, that is, eMBB, URLLC, and mMTC, may be multiplexed and transmitted in a single system. To satisfy different requirements of the respective services, different transmission/reception techniques and transmission/reception parameters may be used between the services.

In the conventional art, however, scheduling in the wireless communication system is deficient. For example, when a frequency resource for uplink subband is scheduled in PDSCH, processing PDSCH might be inefficient.

As such, there is a need in the art for an improved PDSCH scheduling method in a wireless communication system.

### SUMMARY

The disclosure has been made to address at least the above-mentioned problems and/or disadvantages and to provide at least the advantages described below.

Accordingly, an aspect of the disclosure is to provide a method and apparatus for smoothly performing subband non-overlapping full duplex (SBFD)-based communication.

An aspect of the disclosure is to provide Disclosed herein is a method of determining a precoding resource block group (PRG) grid in consideration of an uplink (UL) subband configuration, a method of determining the size of a scheduled physical resource block (PRB), a method of interpreting downlink (DL) and UL BWPs, and a method of determining consecutive DL BWPs.

An aspect of the disclosure is to provide a method of managing a PRB in an SBFD-based communication and a method and apparatus for transmitting or receiving a reference signal (RS) in a wireless communication system.

In accordance with an aspect of the disclosure, there is provided a physical DL shared channel (PDSCH) scheduling method in a wireless communication system, including interpreting scheduling information with reference to information associated with a UL subband when a UE receives a PDSCH from a base station (BS). The interpretation method may be a method of interpreting the size of a scheduled PRB and a BWP size, which are appropriate for full-duplex communication. An embodiment may include a method of determining a PRG grid and a PRB bundling size, which are appropriate for full-duplex communication, when a UE receives a PDSCH from a BS.

In accordance with an aspect of the disclosure, a method includes receiving, from a BS, a first control signal; processing the received first control signal; transmitting, to the BS, a second control signal generated based on the processing.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a time-frequency domain in a wireless communication system according to an embodiment;

FIG. 2 illustrates a frame, a subframe, and a slot in a wireless communication system according to an embodiment;

FIG. 3 illustrates the configuration of a BWP in a wireless communication system according to an embodiment;

FIG. 4 illustrates the configuration of a control area of a DL control channel in a wireless communication system according to an embodiment;

FIG. 5 illustrates a DL control channel in a wireless communication system according to an embodiment;

FIG. 6 illustrates a method of transmitting or receiving data in consideration of a DL data channel and a rate matching resource, by a BS and a UE in a wireless communication system according to an embodiment;

FIG. 7 illustrates frequency-domain resource allocation for a PDSCH in a wireless communication system according to an embodiment;

FIG. 8 illustrates time-domain resource allocation for a PDSCH in a wireless communication system according to an embodiment;

FIG. 9 illustrates time-domain resource allocation according to subcarrier spacings of a data channel and a control channel in a wireless communication system according to an embodiment;

FIG. 10 illustrates the radio protocol structures of a BS and a UE in a single cell case, a carrier aggregation case, and a dual connectivity case in a wireless communication system according to an embodiment;

FIG. 11 illustrate a time division duplex (TDD) configuration and a SBFD configuration according to an embodiment;

FIG. 12 illustrates a method of determining a PRG grid with respect to a scheduled PRB according to an embodiment;

FIG. 13 illustrates a method of configuring a UL subband frequency resource that is aligned with a PRG grid according to an embodiment;

FIG. 14 illustrates a method of configuring a UL subband frequency resource that is not aligned with a PRG grid according to an embodiment;

FIG. 15 illustrates a method of determining a PRG size according to an embodiment;

FIG. 16 is a diagram illustrating a PDSCH configuration scheduled in an SBFD system according to an embodiment;

FIG. 17 illustrates a method of interpreting the size of a scheduled PRB in an SBFD symbol/slot according to an embodiment;

FIG. 18 illustrates a method of interpreting a DL BWP in an SBFD symbol/slot according to an embodiment;

FIG. 19 is a diagram illustrating operation of a UE according to an embodiment;

FIG. 20 is a diagram illustrating operation of a BS according to an embodiment;

FIG. 21 illustrates a UE in a wireless communication system according to an embodiment; and

FIG. 22 illustrates a BS in a wireless communication system according to an embodiment.

### DETAILED DESCRIPTION

Hereinafter, embodiments of the disclosure will be described in detail with reference to the accompanying drawings.

Descriptions related to technical contents well-known in the art and not associated directly with the disclosure will be omitted for the sake of clarity and conciseness.

For the same reason, in the accompanying drawings, some elements may be exaggerated, omitted, or schematically illustrated. The size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure. Throughout the specification, the same or like reference numerals designate the same or like elements. The terms which will be described below are terms defined in consideration of the functions in the disclosure, and may be different according to users, intentions of the users, or customs. Therefore, the definitions of the terms should be made based on the contents throughout the specification.

Herein, a BS is an entity that allocates resources to terminals, and may be at least one of a gNode B, an eNode B, a Node B, a wireless access unit, a BS controller, and a node on a network. A terminal may include a UE, a mobile station (MS), a cellular phone, a smartphone, a computer, or a multimedia system capable of performing communication functions. Herein, the DL refers to a radio link via which a BS transmits a signal to a terminal, and a UL refers to a radio link via which a terminal transmits a signal to a BS. LTE or LTE-A systems may be described by way of example, but the embodiments of the disclosure may also be applied to other communication systems having similar technical backgrounds or channel types. Examples of such communication systems may include 5th generation mobile communication technologies (5G, new radio (NR), etc.) developed beyond LTE-A, and 5G covers the exiting LTE, LTE-A, or other similar services. Based on determinations by those skilled in the art, embodiments herein may also be applied to other communication systems through some modifications without significantly departing from the scope of the disclosure.

A unit herein refers to a software element or a hardware element, such as a field programmable gate array (FPGA) or an application specific integrated circuit (ASIC), which performs a predetermined function. However, the unit does not always have a meaning limited to software or hardware. The unit may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units may be implemented to reproduce one or more CPUs within a device or a security multimedia card, and the unit may include one or more processors.

In the following description, terms for identifying access nodes and for referring to network entities, messages, interfaces between network entities, various identification information, and the like are illustratively used for the sake of descriptive convenience. Therefore, the disclosure is not limited by the terms as used below, and other terms referring to subjects having equivalent technical meanings may be used.

In the following description, terms and names defined in the 3rd generation partnership project long term evolution (3GPP LTE) standards or NR standards will be used for the sake of descriptive convenience. However, the disclosure is not limited by these terms and names, and may be applied in the same manner to systems that conform other standards.

Herein, a BS allocates resources to terminals, and may be at least one of a radio access network (RAN) node, a next generation node B (gNode B, gNB), an evolved node B (eNode B, eNB), a Node B, a wireless access unit, a BS controller, and a node on a network. In the disclosure, the term eNB may be interchangeably used with the term gNB. That is, a BS described as eNB may indicate gNB.

In the following description, a terminal may include a UE, a mobile station (MS), a cellular phone, a smartphone, a computer, or a multimedia system capable of performing communication functions. Of course, examples of the BS and the terminal are not limited thereto.

In particular, the disclosure may be applied to 3GPP NR (5th generation mobile communication standard) and to intelligent services (e.g., smart homes, smart buildings, smart cities, smart cars or connected cars, healthcare, digital education, retail business, security and safety-related services, etc.) on the basis of 5G communication technology and IoT-related technology. A terminal may refer to mobile phones, NB-IOT devices, sensors, and other wireless communication devices.

A method herein may include performing scheduling with reference to information associated with a UL subband when a BS configures PDSCH frequency resource information for a UE, an RB bundling method in consideration of a UL subband when the BS configures the PDSCH frequency resource information for the UE, a method of performing physical RB mapping in a virtual RB when the BS configures the PDSCH frequency resource information for the UE, and a method that does not consider information associated with a UL subband and a method that considers information associated with a UL subband.

### NR Time-Frequency Resources

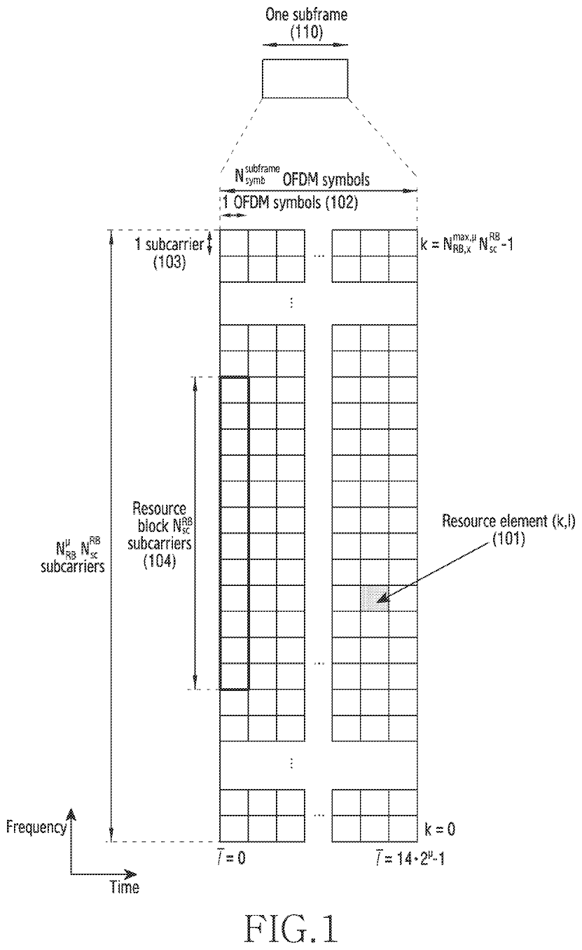

FIG. 1 illustrates a time-frequency domain corresponding to a radio resource area in which data or a control channel is transmitted in a 5G system.

Referring to FIG. 1, the horizontal axis is the time domain and the vertical axis is the frequency domain. In the time and frequency domain, the basic unit for a resource is a resource element (RE) 101 which may be defined by one OFDM symbol 102 in the time axis and one subcarrier 103 in the frequency axis. N_{sc}^{RB} consecutive REs (e.g., 12 REs) in the frequency domain may be a single RB 104.

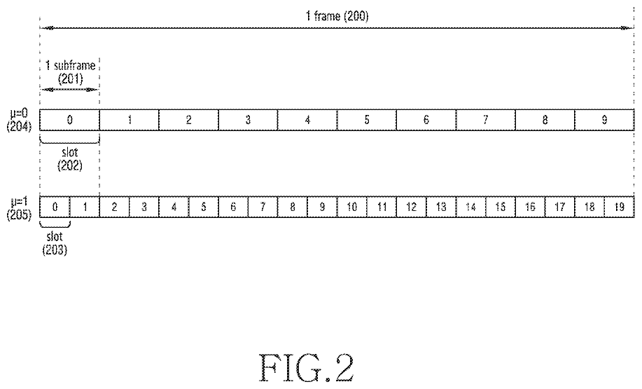

FIG. 2 illustrates a frame, a subframe, and a slot in a wireless communication system according to an embodiment.

Referring to FIG. 2, a frame 200, a subframe 201, and a slot 202 are illustrated. The single frame 200 may be defined as 10 ms. The single subframe 201 may be defined as 1 ms. Therefore, the one frame 200 may include a total of 10 subframes 201. In addition, a single slot 202 and 203 may be defined as 14 OFDM symbols (i.e., the number of symbols per slot (N_{symb}^{slot})=14). The one subframe 201 may include one or multiple slots 202 and 203, and the number of slots 202 and 203 per subframe 201 may differ depending on a set value u 204 and 205 for a subcarrier spacing. The example of FIG. 2 illustrates when a subcarrier spacing set value is μ=0 2-4 and when a subcarrier spacing set value is μ=1 205. In the case of μ=0 204, the single subframe 201 may include one slot 202. In the case of μ=1 205, the single subframe 201 may include two slots 203. That is, depending on a set value u for a subcarrier spacing, the number of slots per subframe (Nₛₗₒₜ^{subframe,μ}) may also differ. Accordingly, the number of slots per frame (Nₛₗₒₜ^{frame,μ}) may differ Nₛₗₒₜ^{subframe,μ} and Nₛₗₒₜ^{frame,μ} based on a subcarrier spacing set value u may be defined as shown below in Table 1.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### BWP

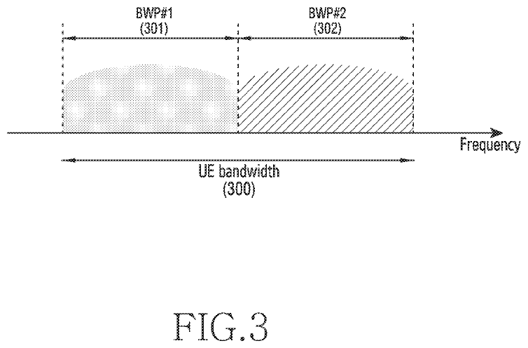

FIG. 3 illustrates a configuration of a BWP in a wireless communication system according to an embodiment.

FIG. 3 shows an example in which two BWPs, that is, BWP #1 301 and BWP #2 302, are configured in a UE bandwidth 300. A BS may configure a single BWP or multiple BWPs for a UE, and may configure the information shown below in Table 2, for each BWP.

TABLE 2

| | |
|---|---|
| BWP ::= | SEQUENCE { |
| bwp-Id | BWP-Id, |

(Bandwidth part identifier)

| | |
|---|---|
| locationAndBandwidth | INTEGER (1..65536), |

(Bandwidth part location)

| | |
|---|---|
| subcarrierSpacing | ENUMERATED {n0, n1, n2, n3, n4, n5}, |

(Subcarrier spacing)

| | |
|---|---|
| cyclicPrefix | ENUMERATED { extended } |

(Cyclic prefix)
}

The information is not limited to the above-described example, and various parameters related to a BWP in addition to the configuration information may be configured for a UE. The information may be transferred by a BS to a UE via higher layer signaling, e.g., radio resource control (RRC) signaling. At least one BWP among the configured one or multiple BWPs may be activated. Whether a configured BWP is activated may be transferred from a BS to a UE semi-statistically via RRC signaling, or dynamically via DL control information (DCI).

Prior to having a connection to an RRC, a UE may receive a configuration of an initial BWP for initial access from a BS via a master information block (MIB). More specifically, via the MIB at the initial access stage, the UE may receive configuration information associated with a search space and a control area (e.g., a control resource set (CORESET)) in which a physical DL control channel (PDCCH) is transmitted, to receive system information (e.g., remaining system information (RMSI) or system information block 1 (SIB1)) needed for initial access. The control area and the search space configured via the MIB may be regarded as an identity (ID) of 0, respectively. The BS may inform the UE of the configuration information, such as frequency allocation information, time allocation information, numerology, or the like, in association with control area #0, via the MIB. In addition, the BS may inform the UE of configuration information associated with a monitoring cycle and occasion with respect to control area #0, that is, configuration information for search space #0, via the MIB. The UE may consider, as an initial BWP for initial access, a frequency domain configured as control area #0 obtained from the MIB. In this instance, the identity (ID) of the initial BWP may be considered as 0.

A BWP configuration supported in 5G may be used for various purposes.

According to some embodiments, when a bandwidth supported by a UE is less than a system bandwidth, the BWP configuration may be used for backup. For example, a BS configures, for a UE, the frequency location of a BWP (configuration information 2) so that the UE is capable of transmitting or receiving data at a predetermined frequency location in the system bandwidth.

To support different numerologies, a BS may configure multiple BWPs for a UE. For example, to support data transmission or reception using both a subcarrier spacing of 15 kHz and a subcarrier spacing of 30 kHz for a UE, the two BWPs may be configured to have a subcarrier spacing of 15 kHz and a subcarrier spacing of 30 kHz, respectively. The different BWPs may be frequency division multiplexed (frequency division multiplexing), and when data transmission or reception based on a predetermined subcarrier spacing is needed, a BWP configured to have the corresponding subcarrier spacing may be activated.

A BS may configure BWPs having different bandwidths for a UE to reduce power consumption of the UE. For example, when the UE supports a bandwidth of 100 MHz, and always transmits or receives data using the corresponding bandwidth, a significantly large amount of power may be consumed. Particularly, when there is no traffic, monitoring an unnecessary DL control channel in a large bandwidth of 100 MHz may be inefficient from the perspective of power consumption. Accordingly, to reduce the power consumption of the UE, the BS may configure a BWP that is a relatively smaller bandwidth, for example, a BWP of 20 MHz, for the UE. When there is no traffic, the UE may perform monitoring in a BWP of 20 MHz, and when data is produced, the UE may transmit or receive the data in a BWP of 100 MHz according to an instruction form the BS.

In a method of configuring a BWP, UEs before being connected to an RRC may receive configuration information associated with an initial BWP via an MIB in the initial access stage. More specifically, the UE may receive, from the MIB of a physical broadcast channel (PBCH), a configuration of a control area for a DL control channel in which DCI that schedules a system information block (SIB) may be transmitted. The bandwidth of a control area configured via the MIB may be regarded as an initial BWP, and the UE may receive, via the configured initial BWP, a physical DL shared channel (PDSCH) that transmits an SIB. In addition to the purpose of receiving the SIB, the initial BWP may be utilized for other system information (OSI), paging, or random access.

### BWP Change

When one or more BWPs are configured for a UE, a BS may indicate, to the UE, changing (or switching or shifting) of a BWP by using a BWP indicator field in DCI. For example, in FIG. 3, when a currently activated BWP of a UE is BWP #1 301, a BS may indicate, to the UE, BWP #2 302 using a BWP indicator in DCI. The UE may perform BWP switching to BWP #2 302 indicated by the received BWP indicator in the DCI.

As described above, DCI-based BWP switching may be indicated by DCI that schedules a PDSCH or PUSCH, and thus, when a UE receives a BWP switch request, the UE may need to smoothly receive or transmit a PDSCH or PUSCH scheduled by the corresponding DCI in the switched BWP. To this end, the standard has defined requirements associated with a delay time (TBWP) required for BWP switching, and for example, the requirements may be defined as shown below in Table 3.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of SCS, the BWP switch delay is determined by the larger one between the SCS before BWP switch and the SCS after BWP switch.

The requirements associated with a BWP delay time may support type 1 or type 2 depending on the capability of a UE. A UE may report a supportable BWP delay time type to a BS.

According to requirements for the BWP switch delay time, when the UE receives DCI including a BWP switch indicator in slot n, the UE may complete switching to a new BWP indicated by the BWP switch indicator at a point in time not later than slot n+TBWP, and may perform transmission or reception of a data channel that the corresponding DCI schedules in the new switched BWP. When a BS desires to schedule a data channel in a new BWP, the BS may determine time-domain resource allocation with respect to a data channel in consideration of a BWP switch delay time (TBWP) of a UE. That is, in the method in which s BS determines time-domain resource allocation with respect to a data channel when scheduling a data channel in a new data BWP, the corresponding data channel may be scheduled to be after the BWP switch delay time. Accordingly, the UE may not expect that the DCI indicating switching of a BWP indicates a slot offset (K0 or K2) value less than a TBWP.

When a UE receives DCI (e.g., DCI format 1_1 or 0_1) indicating switching of a BWP, the UE may not perform any transmission or reception during a time interval from a third symbol of a slot in which a PDCCH including the corresponding DCI is received to the start point of a slot indicated by a slot offset (K0 or K2) value indicated by a time-domain resource allocation indicator field in the corresponding DCI. For example, when a UE receives DCI indicating switching of a BWP in slot n and a slot offset value indicated by the corresponding DCI is K, the UE may not perform any transmission or reception from the third symbol of slot n to a symbol before slot n+K (i.e., the last symbol of slot n+K−1).

### SS/PBCH Block

A synchronization signal (SS)/PBCH block may be a physical layer channel block including a primary SS (PSS), a secondary SS (SSS), and a PBCH. Specifically, elements included in an SS/PBCH block (or SSB) may be defined as below.

PSS is an RS for DL time/frequency synchronization, which provides part of information of a cell ID.

SSS acts as a reference for DL time/frequency synchronization, and provides the remaining cell ID information that the PSS does not provide. In addition, the SSS may act as an RS for demodulating a PBCH.

PBCH provides essential system information needed for a UE to perform data channel and control channel transmission or reception. The essential system information may include search space-related control information indicating radio resource mapping information of a control channel, scheduling control information associated with a separate data channel that transmits system information, and the like.

SS/PBCH block includes a combination of a PSS, an SSS, and a PBCH. A single SS/PBCH block or multiple SS/PBCH blocks may be transmitted within 5 ms, and each transmitted SS/PBCH block may be identified based on an index.

At the initial access stage, a UE may detect a PSS and an SSS, and may decode a PBCH. The UE may obtain an MIB from the PBCH, whereby CORESET #0 (corresponding to a control area having a control area index of 0) may be configured. The UE may assume that a selected SS/PBCH block and a demodulation RS (DMRS) transmitted in control area #0 are in a quasi co location (QCL) and may monitor control area #0. The UE may receive system information via DCI transmitted in control area #0. From the received system information, the UE may obtain random access channel (RACH)-related configuration information needed for initial access. The UE may transmit a physical RACH (PRACH) to a BS in consideration of the selected SS/PBCH index, and the BS that receives the PRACH may obtain information associated with the index of the SS/PBCH block that the UE selects. The BS may recognize a block that the UE selects among SS/PBCH blocks and the fact that the UE monitors control area #0 related to the selected block.

### PDCCH: Matters Relevant to DCI

In the 5G system, scheduling information for a physical UL shared channel (PUSCH) or a physical DL shared channel (PDSCH) may be included in DCI and transferred from a BS to a UE. A UE may monitor (monitoring) a DCI format for fallback and a DCI format for non-fallback in association with a PUSCH or PDSCH. The fallback DCI format may be configured as a fixed field previously defined between a BS and a UE, and the non-fall back DCI format may include a field that is capable of being configured.

DCI may go through a channel-coding and modulating process, and may be transmitted in a PDCCH which is a DL physical control channel. A cyclic redundancy check (CRC) is added to a DCI message payload, and the CRC may be scrambled by a radio network temporary identifier (RNTI) corresponding to a UE identity. Different RNTIs may be used depending on the purpose of the DCI message, e.g., UE-specific data transmission, power control command, random access response (RAR), etc. That is, an RNTI is not explicitly transmitted, but is transmitted by being included in a CRC calculation process. When a UE receives a DCI message transmitted in a PDCCH, the UE may identify a CRC by using an allocated RNTI and may recognize that the corresponding message is transmitted for the UE in case a CRC identification result is right.

For example, DCI that schedules a PDSCH associated with system information (SI) may be scrambled by an SI-RNTI. DCI that schedules a PDSCH associated with an RAR message may be scrambled by an RA-RNTI. DCI that schedules a PDSCH associated with a paging message may be scrambled by a P-RNTI. A DCI that reports a slot format indicator (SFI) may be scrambled by an SFI-RNTI. DCI that reports a transmit power control (TPC) may be scrambled by a TPC-RNTI. DCI that schedules a UE-specific PDSCH or PUSCH may be scrambled by a cell RNTI (C-RNTI).

DCI format 0_0 may be used as a fallback DCI that schedules a PUSCH. In this instance, a CRC may be scrambled by a C-RNTI. DCI format 0_0 with a CRC, scrambled by a C-RNTI, may include, for example, the information shown below in Table 4.

TABLE 4

| | |
|---|---|
| - | Identifier for DCI formats (DCI format identifier) - [1] bit |
| - | Frequency domain resource assignment (Frequency domain resource assignment) - |

[┌log ₂ (N_{RB}^{UL,BWP} (N_{RB}^{UL,BWP} + 1) / 2)┐ ] bits

| | |
|---|---|
| - | Time domain resource assignment (Time domain resource assignment) - X bits |
| - | Frequency hopping flag (Frequency hopping flag) - 1 bit. |
| - | Modulation and coding scheme (Modulation and coding scheme) - 5 bits |
| - | New data indicator (NDI) - 1 bit |
| - | Redundancy version (RV) - 2 bits |
| - | hybrid automatic repeat request (HARQ) process number (HARQ process number) - 4 bits |
| - | TPC command for scheduled PUSCH (Transmit power control (TPC) command for scheduled |

PUSCH - [2] bits

| | |
|---|---|
| - | UL/SUL indicator (UL/supplementary UL (UL/SUL) identifier) - 0 or 1 bit |

DCI format 0_1 may be used as a non-fallback DCI that schedules a PUSCH. In this instance, a CRC may be scrambled by a C-RNTI. DCI format 0_1 with a CRC, scrambled by a C-RNTI, may include, for example, the information shown below in Table 5.

TABLE 5

| - | Carrier indicator (Carrier indicator) - 0 or 3 bits | |
|---|---|---|
| - | UL/SUL indicator - 0 or 1 bit | |
| - | Identifier for DCI formats - [1] bits | |
| - | BWP indicator- 0, 1 or 2 bits | |
| - | Frequency domain resource assignment | |
| | • | For resource allocation type 0(For resource allocation type 0), |
| | | ┌N_{RB}^{UL,BWP} / P┐ bits |
| | • | For resource allocation type 1(For resource allocation type 1), |
| | | ┌log₂(N_{RB}^{UL,BWP}(N_{RB}^{UL,BWP} + 1)/2)┐ bits |

| | |
|---|---|
| - | Time domain resource assignment -1, 2, 3, or 4 bits |
| - | VRB-to-PRB mapping (Virtual RB-to-physical RB mapping) - 0 or 1 bit, only for |

resource allocation type 1.

| | • | 0 bit if only resource allocation type 0 is configured; |
|---|---|---|
| | • | 1 bit otherwise. |
| - | Frequency hopping flag - 0 or 1 bit, only for resource allocation type 1. | |
| | • | 0 bit if only resource allocation type 0 is configured; |
| | • | 1 bit otherwise. |
| - | Modulation and coding scheme - 5 bits | |
| - | NDI - 1 bit | |
| - | RV - 2 bits | |
| - | HARQ process number - 4 bits | |
| - | 1st DL assignment index (First DL assignment index)- 1 or 2 bits | |
| | • | 1 bit for semi-static HARQ-ACK codebook(For semi-static HARQ- |
| | | ACK codebook); |
| | • | 2 bits for dynamic HARQ-ACK codebook with single HARQ-ACK |
| | | codebook(When dynamic HARQ-ACK codebook is used with a single |
| | | HARQ-ACK codebook). |
| - | | 2nd DL assignment index (Second DL assignment index) - 0 or 2 bits |
| | • | 2 bits for dynamic HARQ-ACK codebook with two HARQ-ACK sub- |
| | | codebooks(When dynamic HARQ-ACK codebook is used with two |
| | | HARQ-ACK sub-codebooks); |
| | • | 0 bit otherwise. |
| - | | TPC command for scheduled PUSCH - 2 bits |
| - | | SRS resource indicator (SRS resource indicator) - |
| - | | $SRS resource indicator ( SRS resource indicator ) - ⌈ {log}_{2} ( {{\sum }_{k = 1}}^{{L}_{ma x}} ( \begin{matrix}{N}_{S R S} \\ k\end{matrix} ) ) ⌉ or$ |

┌log₂(N_{SRS})] bits

| | | |
|---|---|---|
| | • | $⌈ {log}_{2} ( {{\sum }_{k = 1}}^{{L}_{ma x}} ( \begin{matrix}{N}_{S R S} \\ k\end{matrix} ) ) ⌉ bits for non - codebook based PUSCH$ |
| | | transmission(When PUSCH transmission is not based on codebook); |
| | • | [log₂(N_{SRS})┐ bits for codebook based PUSCH transmission(When |
| | | PUSCH transmission is based on codebook). |
| - | | Precoding information and number of layers (Precoding information and the |

number of layers)-up to 6 bits

| | |
|---|---|
| - | Antenna ports (Antenna port)- up to 5 bits |
| - | SRS request (Request SRS)- 2 bits |
| - | CSI request (Channel state information request) - 0, 1, 2, 3, 4, 5, or 6 bits |
| - | CBG transmission information (Code block group transmission information)- |

0, 2, 4, 6, or 8 bits

| | |
|---|---|
| - | PTRS-DMRS association (Phase tracking reference signal (PTRS)- |

demodulation reference signal (DMRS) association)- 0 or 2 bits.

| | |
|---|---|
| - | beta_offset indicator (Beta offset indicator)- 0 or 2 bits |
| - | DMRS sequence initialization (Demodulation reference signal sequence (DMRS) |

initialization)- 0 or 1 bit

DCI format 1_0 may be used as a fallback DCI that schedules a PDSCH. In this instance, a CRC may be scrambled by a C-RNTI. DCI format 1_0 with a CRC, scrambled by a C-RNTI, may include, for example, the information shown below in Table 6.

TABLE 6

| | |
|---|---|
| - | Identifier for DCI formats [1] bit |
| - | Frequency domain resource assignment - [┌log ₂ (N_{RB}^{DL,BWP} (N_{RB}^{DL,BWP} +1) / 2)┐ ] bits |
| - | Time domain resource assignment - X bits |
| - | VRB-to-PRB mapping - 1 bit. |
| - | Modulation and coding scheme - 5 bits |
| - | NDI - 1 bit |
| - | RV - 2 bits |
| - | HARQ process number - 4 bits |
| - | DL assignment index - 2 bits |
| - | TPC command for scheduled PUCCH - bits |
| - | PUCCH resource indicator (Physical UL control channel (PUCCH) resource |

indicator - 3 bits

| | |
|---|---|
| - | PDSCH-to-HARQ feedback timing indicator (PDSCH-to-HARQ feedback |

timing indicator)- [3] bits

DCI format 1_1 may be used as a non-fallback DCI that schedules a PDSCH. In this instance, a CRC may be scrambled by a C-RNTI. DCI format 1_1 with a CRC, scrambled by a C-RNTI, may include, for example, the information shown below in Table 7.

TABLE 7

| | |
|---|---|
| - | Carrier indicator - 0 or 3 bits |
| - | Identifier for DCI formats [1] bits |
| - | BWP indicator - 0, 1 or 2 bits |
| - | Frequency domain resource assignment |
| | • For resource allocation type 0, ┌_{RB}^{DL,BWP} / P┐ bits |
| | • For resource allocation type 1, ┌log ₂ (N_{RB}^{DL,BWP} (N_{RB}^{DL,BWP} +1) / 2)┐ bits |
| - | Time domain resource assignment -1, 2, 3, or 4 bits |
| - | VRB-to-PRB mapping - 0 or 1 bit, only for resource allocation type 1. |
| | • 0 bit if only resource allocation type 0 is configured; |
| | • 1 bit otherwise. |
| - | PRB bundling size indicator - 0 or 1 bit |
| - | Rate matching indicator (Rate matching indicator) - 0, 1, or 2 bits |
| - | ZP CSI-RS trigger (Zero power (ZP) channel state information reference signal |

(CSI-RS) trigger) - 0, 1, or 2 bits
For transport block 1(For first transmission block):

| | |
|---|---|
| - | Modulation and coding scheme - 5 bits |
| - | NDI - 1 bit |
| - | RV - 2 bits |

For transport block 2(For second transmission block):

| | |
|---|---|
| - | Modulation and coding scheme - 5 bits |
| - | NDI - 1 bit |
| - | RV - 2 bits |
| - | HARQ process number - 4 bits |
| - | DL assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication (Transmission configuration |

indication)- 0 or 3 bits

| | |
|---|---|
| - | SRS request - 2 bits |
| - | CBG transmission information - 0, 2, 4, 6, or 8 bits |
| - | CBG flushing out information (Code block group (CBG) flushing out |

information) - 0 or 1 bit

| | |
|---|---|
| - | DMRS sequence initialization - 1 bit |

### PDCCH: CORESET, REG, CCE, Search Space

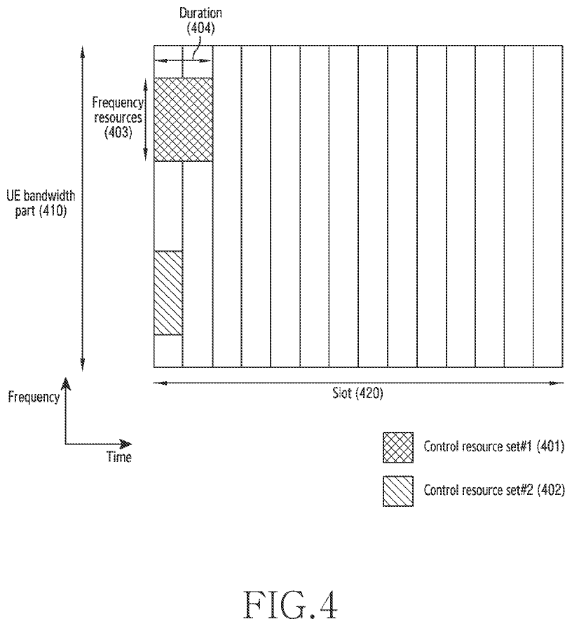

FIG. 4 illustrates a CORESET in which a DL control channel is transmitted in the 5G wireless communication system. FIG. 4 illustrates an example in which a UE BWP 410 is configured in the frequency axis and two control areas (control area #1 401 and control area #2 402) are configured within one slot 420 in the time axis. The control areas 401 and 402 may be configured in a predetermined frequency resource 403 within the entire UE BWP 410 in the frequency axis. In the time axis, the control area may be configured with one or multiple OFDM symbols, which may be defined as a control area length (CORESET duration 404). With reference to the example of FIG. 4, the control area #1 401 is configured based on a control area length of two symbols, and the control area #2 402 is configured based on a control area length of one symbol.

The above-described control area in 5G may be configured by a BS for a UE via higher layer signaling (e.g., system information, an MIB, RRC signaling). Configuring a control area for a UE may be providing information associated with the identity of the control area, the frequency location of the control area, the length of symbols of the control area, and the like. For example, pieces of information of Table 8 as shown below may be included.

TABLE 8

| | |
|---|---|
| ControlResourceSet ::= | SEQUENCE { |

```
    -- Corresponds to L1 parameter ‘CORESET-ID’
    controlResourceSetId
          ControlResourceSetId,
      (Control area identity)
```

| | |
|---|---|
| frequencyDomainResources | BIT STRING |

```
    (SIZE (45)),
    (Frequency domain resource allocation information)
    duration
          INTEGER (1..maxCoReSetDuration),
    (Time domain resource allocation information)
    cce-REG-MappingType
          CHOICE {
      (CCE-to-REG mapping scheme)
          interleaved
              SEQUENCE {
              reg-BundleSize
              ENUMERATED {n2, n3, n6},
          (REG bundle size)
            precoderGranularity
            ENUMERATED {sameAsREG-bundle, allContiguousRBs},
            interleaverSize
            ENUMERATED {n2, n3, n6}.
            (Interleaver size)
            shiftIndex
```

INTEGER(0..maxNrofPhysicalResourceBlocks-1)

```
        OPTIONAL
          (Interleaver shift)
      },
  nonInterleaved
        NULL
  },
  tci-StatesPDCCH
        SEQUENCE(SIZE (1..maxNrofTCI-StatesPDCCH)) OF TCI-StateId
```

OPTIONAL,

(QCL configuration information)

In Table 8, tci-StatesPDCCH (or a transmission configuration indication (TCI) state) configuration information may include information associated with one or multiple SS)/PBCH blocks indices that are in QCL relationship with a DMRS transmitted in a corresponding control area or information associated with a channel state information RS (CSI-RS) index.

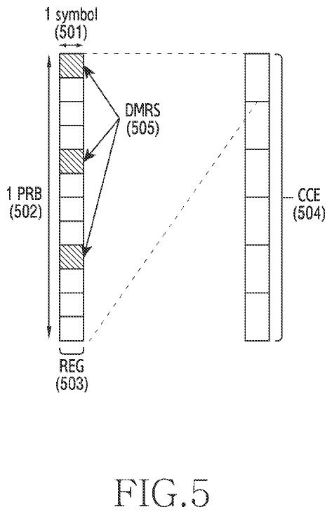

FIG. 5 illustrates the basic unit of a time and frequency resource configured for a DL control channel usable in 5G. According to FIG. 5, a basic unit of a time and frequency resource configured for a control channel may be an RE group (REG) 503, and the REG 503 may be defined by 1 OFDM symbol 501 in the time axis and 1 PRB 502, that is, 12 subcarriers, in the frequency axis. A BS may configure a DL control channel allocation unit by concatenating REGs 503.

As illustrated in FIG. 5, when a basic unit in which a DL control channel is allocated in 5G is a CCE 504, 1 CCE 504 may include a plurality of REGs 503. A description will be provided with reference to the REG 503 of FIG. 5. When the REG 503 includes 12 REs and 1 CCE 504 includes 6 REGs 503, 1 CCE 504 includes 72 REs. When a DL control area is configured, the corresponding area includes a plurality of CCEs 504, and a predetermined DL control channel may be transmitted by being mapped to a single CCE or multiple CCEs 504 according to an aggregation level (AL) in the control area. The CCEs 504 in the control area may be distinguished by numbers, and the numbers for the CCEs 504 may be assigned according to a logical mapping scheme.

The basic unit of a DL control channel of FIG. 5, that is, the REG 503, may include REs to which DCI is mapped and an area to which a DMRS 505, which is an RS for decoding the same, is mapped. As illustrated in FIG. 5, three DMRSs 505 may be transmitted in 1 REG 503. The number of CCEs needed for transmitting a PDCCH may be 1, 2, 4, 8, or 16 depending on an aggregation level (AL), and a different number of CCEs may be used for embodying link adaptation of a DL control channel. For example, in case of AL=L, a single DL control channel may be transmitted via L CCEs. A UE needs to detect a signal without knowing information associated with a DL control channel. A search space indicating a set of CCEs is defined for blind decoding. A search space is a set of candidate DL control channels including CCEs which a UE is supposed to attempt to decode at a given aggregation level. There are various aggregation levels for binding 1, 2, 4, 8, or 16 CCEs into a single bundle, and thus a UE has multiple search spaces. A search space set may be defined as a set of search spaces at all configured aggregation levels.

A search space may be classified as a common search space and a UE-specific search space. A group of UEs or all UEs may investigate the common search space of a PDCCH to receive cell-common control information such as a dynamic scheduling or paging message associated with system information. For example, PDSCH scheduling allocation information for transmitting an SIB including operator information of a cell and the like may be received via investigation of the common search space for a PDCCH. The common search space may be defined as a set of predetermined CCEs since a group of UEs or all UEs may need to receive a PDCCH. Scheduling allocation information for a UE-specific PDSCH or a PUSCH may be received via investigation of a UE-specific search space for a PDCCH. The UE-specific search space may be defined to be specific to a UE by using an identity of the UE and a function with various system parameters.

In 5G, a parameter for the search space of a PDCCH may be configured for a UE by a BS via higher layer signaling (e.g., SIB, MIB, RRC signaling). For example, a BS may configure, for a UE, the number of candidate PDCCHs at each aggregation level L, a monitoring cycle for a search space, search space monitoring occasion in units of symbols in a slot, a search space type (e.g., a common search space or UE-specific search space), a DCI format and RNTI combination desired to be monitored in the corresponding search space, the index of a control area in which a search space is desired to be monitored, and the like. For example, pieces of information of Table 9 shown below may be included.

TABLE 9

| | |
|---|---|
| SearchSpace ::= | SEQUENCE { |

```
    -- Identity of the search space SearchSpaceId = 0 identifies the SearchSpace configured via PBCH
    (MIB) or ServingCellConfigCommon.
```

| | |
|---|---|
| searchSpaceId | SearchSpaceId, |

(Search space identifier)

| | |
|---|---|
| controlResourceSetId | ControlResourceSetId, |

(Control area identifier)

| | |
|---|---|
| monitoringSlotPeriodicityAndOffset | CHOICE { |

```
        (Monitoring slot level cycle)
            sl1
            NULL,
            sl2
            INTEGER (0..1),
            sl4
            INTEGER (0..3),
            sl5
            INTEGER (0..4),
            sl8
            INTEGER (0..7),
            sl10
            INTEGER (0..9),
            sl16
            INTEGER (0..15),
            sl20
            INTEGER (0..19)
    }
```

| | |
|---|---|
| | OPTIONAL, |
| duration (Monitoring duration) | INTEGER (2..2559) |

monitoringSymbolsWithinSlot

| | |
|---|---|
| (14)) | BIT STRING (SIZE |
| | OPTIONAL, |

(Monitoring symbol in slot )

| | |
|---|---|
| nrofCandidates | SEQUENCE { |

(Number of candidate PDCCHs at each AL )

| | |
|---|---|
| aggregationLevel1 | ENUMERATED {n0, |

n1, n2, n3, n4, n5, n6, n8},

| | |
|---|---|
| aggregationLevel2 | ENUMERATED {n0, |

n1, n2, n3, n4, n5, n6, n8},

| | |
|---|---|
| aggregationLevel4 | ENUMERATED {n0, |

n1, n2, n3, n4, n5, n6, n8},

| | |
|---|---|
| aggregationLevel8 | ENUMERATED {n0, |

n1, n2, n3, n4, n5, n6, n8},

| | |
|---|---|
| aggregationLevel16 | ENUMERATED {n0, |

```
      n1, n2, n3, n4, n5, n6, n8}.
      },
```

| | |
|---|---|
| searchSpaceType | CHOICE { |

```
        (Search space type)
              -- Configures this search space as common search space (CSS) and DCI formats to monitor,
              common
              SEQUENCE {
      (Common search space)
          }
              ne-Specific
              SEQUENCE {
      (UE-specific search space)
              -- Indicates whether the UE monitors in this USS for DCI formats 0-0 and 1-0 or for
      formats 0-1 and 1-1.
              formats
              ENUMERATED [formats0-0-And-1-0, formats0-1-And-1-1},
              ...
              }
```

According to the configuration information, a BS may configure, for a UE, a single search space set or multiple search space sets. A BS may configure search space set 1 and search space set 2 for a UE, may perform configuration so that the UE monitors DCI format A scrambled by X-RNTI in search space set 1 in a common search space, and may perform configuration so that the UE monitors DCI format B scrambled by Y-RNTI in search space set 2 in a UE-specific search space.

According to configuration information, a single search space set or multiple search space sets may be present in the common search space or UE-specific search space. For example, search space set #1 and search space set #2 may be configured as a common search space, and search space set #3 and search space set #4 may be configured as a UE-specific search space.

In a common search space, the following combinations of a DCI format and an RNTI may be monitored. However, this is not limited to the following example.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In a UE-specific search space, the following combinations of a DCI format and an RNTI may be monitored.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The RNTIs specified below may comply with the following definitions and use.
Cell RNTI (C-RNTI): for UE-specific PDSCH scheduling
Temporary cell RNTI (TC-RNTI): for UE-specific PDSCH scheduling
Configured scheduling RNTI (CS-RNTI): for semi-statically configured UE-specific PDSCH scheduling
Random access RNTI (RA-RNTI): for PDSCH scheduling in a random access process
Paging RNTI (P-RNTI): for scheduling a PDSCH in which paging is transmitted
System information RNTI (SI-RNTI): for scheduling a PDSCH in which system information is transmitted
Interruption RNTI (INT-RNTI): for reporting whether to perform puncturing of a PDSCH
TPC for PUSCH RNTI (TPC-PUSCH-RNTI): for commanding power control for a PUSCH
TPC for PUCCH RNTI (TPC-PUCCH-RNTI): for commanding power control for a PUCCH

TPC for SRS RNTI (TPC-SRS-RNTI): for commanding power control for an SRS The above-described DCI formats may comply with the definitions shown below in Table 10.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and |
| | PUSCH |
| 2_3 | Transmission of a group of TPC commands for |
| | SRS transmissions by one or more UEs |

In 5G, a search space at aggregation level L in search space set s and control area p may be expressed as given in Equation (1) below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad ( 1 )$$

In Equation (1),
L: aggregation level
n_{CI}: carrier index
N_{CCE,p}: the total number of CCEs in control area p
n_{s,f}^{μ}: slot index
M_{s,max}^{(L)}: the number of candidate PDCCHs at aggregation level L
   m_{s,n}_{_{CI}}=0, . . . , M_{s,max}^{(L)}−1: candidate PDCCH indices at aggregation level L i=0, . . . , L−1
Y_{p,n}_{_{s,f}}^{μ}=(Aₚ·Y_{p,n}_{_{s,f}}^{μ}−1) mod D, Y_{p,-1}=n_{RNTI}≠0, Aₚ=39827 for pmod3=0, Aₚ=39829 for pmod3=1, Aₚ=39839 for pmod3=2, D=65537
n_{RNTI}: UE identifier

In a common search space, Y_{p,n}_{_{s,f}}^{μ} may correspond to 0.

Y_{p,n}_{_{s,f}}^{μ} may correspond to a value that differs based on a UE ID (C-RNTI or ID that a BS configures for a UE) and a time index, in the case of a UE-specific search space.

In 5G, multiple search space sets may be configured with different parameters in Table 9, and thus a set of search space sets that a UE monitors for each point in time may be different. For example, when search space set #1 is configured based on a X-slot cycle, search space set #2 is configured based on a Y-slot cycle, and X and Y are different, a UE may monitor both search space set #1 and search space set #2 in a predetermined slot, and may monitor one of search space set #1 and search space #2 in a predetermined slot.

### PDCCH: BD/CCE Limit

When multiple search space sets are configured for a UE, a method of determining a search space set to be monitored by the UE may be performed in consideration of the following conditions.

When the UE is configured with r15monitoringcapability as the value of monitoringCapabilityConfig-r16 that is higher layer signaling, the UE may define the maximum value of the number of candidate PDCCUs that the UE is capable of monitoring and the maximum value of the number of CCEs included in the entire search space, which corresponds to the union area of multiple search space sets, for each slot. When the UE is configured with r16monitoringcapability as the value of monitoringCapabilityConfig-r16, the UE may define the maximum value of the number of candidate PDCCUs that the UE is capable of monitoring and the maximum value of the number of CCEs included in the entire search space for each span.

### Condition 1: A Limit to the Maximum Number of Candidate PDCCHs

According to a configuration value of higher layer signaling as described above, when the maximum number M\hat{ }μ of candidate PDCCHs that the UE is capable of monitoring is defined based on a slot in a cell in which a subcarrier spacing of 15*2\hat{ }μ kHz is configured, the maximum number may comply with Table 11 shown below, and when the maximum number is defined based on a span, the maximum number may comply with Table 12 shown below.

TABLE 11

| | Maximum number of PDCCH candidates per |
|---|---|
| μ | slot and per serving cell (M^{μ}) |
| 0 | 44 |
| 1 | 36 |
| 2 | 22 |
| 3 | 20 |

TABLE 12

| | Maximum number M^{μ} of monitored PDCCH | | |
|---|---|---|---|
| | candidates per span for combination (X, Y) | | |
| | and per serving cell | | |
| μ | (2, 2) | (4, 3) | (7, 3) |
| 0 | 14 | 28 | 44 |
| 1 | 12 | 24 | 36 |

### Condition 2: A Limit to the Maximum Number of CCEs

According to a configuration value of higher layer signaling as described above, when the maximum number Cμ of CCEs included in the entire search space is defined based on a slot in a cell in which a subcarrier spacing of 15*2\hat{ }μ kHz is configured, the maximum number may comply with Table 13 shown below, and when the maximum number is defined based on a span, the maximum number may comply with Table 14 shown below.

TABLE 13

| | Maximum number of non-overlapped CCEs per slot and |
|---|---|
| μ | per serving cell (C^{μ}) |
| 0 | 56 |
| 1 | 56 |
| 2 | 48 |
| 3 | 32 |

TABLE 14

| | Maximum number C^{μ} of non-overlapped | | |
|---|---|---|---|
| | CCEs per span for combination (X, Y) and | | |
| | per serving cell | | |
| μ | (2, 2) | (4, 3) | (7, 3) |
| 0 | 18 | 36 | 56 |
| 1 | 18 | 36 | 56 |

For ease of description, a situation that satisfies both conditions 1 and 2 at a predetermined point in time is defined as “condition A”. Therefore, the fact that condition A is not satisfied implies that at least one of condition 1 and condition 2 is not satisfied.

### Rate Matching/Puncturing

When time and frequency resource A in which symbol sequence A is desired to be transmitted overlaps time and frequency resource B, rate matching or puncturing may be considered as an operation for transmitting or receiving channel A in consideration of resource C of an area where resource A and resource B overlap. A detailed operation is as follows.

### Rate Matching

A BS may map channel A to only a resource area remaining after excluding resource C corresponding to an area that overlaps with the resource B from the entire resource A in which symbol sequence A is desired to be transmitted, and may transmit the same to a UE. For example, when symbol sequence A is configured with {symbol #1, symbol #2, symbol #3, symbol #4}, resource A is {resource #1, resource #2, resource #3, resource #4} and resource B is {resource #3, resource #5}, a BS sequentially map symbol sequence A to the resource {resource #1, resource #2, resource #4} remaining after excluding {resource #3} corresponding to resource C from resource A, and may transmit the same. Accordingly, the BS may map the symbol sequence {symbol #1, symbol #2, symbol #3} to {resource #1, resource #2, resource #4}, respectively, and may transmit the same.

The UE may determine resource A and resource B based on scheduling information associated with symbol sequence A obtained from the BS, and thus may determine resource C that is the area where resource A and resource B overlap. The UE may assume that symbol sequence A is mapped to the remaining area excluding resource C from the entire resource A and is transmitted, and may receive symbol sequence A. For example, when symbol sequence A is configured with {symbol #1, symbol #2, symbol #3, symbol #4}, resource A is {resource #1, resource #2, resource #3, resource #4}, and resource B is {resource #3, resource #5}, the UE may assume that symbol sequence A is sequentially mapped to the resource {resource #1, resource #2, resource #4} remaining after excluding {resource #3} corresponding to resource C from resource A, and may receive the same. Accordingly, the UE may assume that the symbol sequence {symbol #1, symbol #2, symbol #3} is mapped to {resource #1, resource #2, resource #4}, respectively, and is transmitted, and may perform a series of subsequent reception operations.

### Puncturing

When resource C corresponding to an area that overlaps with resource B is present in the entire resource A in which symbol sequence A is desired to be transmitted to a UE, a BS may map symbol sequence A map to the entire resource A. However, the BS does not perform transmission in the resource area corresponding to resource C but may perform transmission only in the resource area remaining after excluding resource C from the resource A. For example, when symbol sequence A is configured with {symbol #1, symbol #2, symbol #3, symbol #4}, resource A is {resource #1, resource #2, resource #3, resource #4}, and resource B is {resource #3, resource #5}, the BS may map symbol sequence A {symbol #1, symbol #2, symbol #3, symbol #4} to the resource A {resource #1, resource #2, resource #3, resource #4}, respectively, and may transmit only a symbol sequence {symbol #1, symbol #2, symbol #4} corresponding to {resource #1, resource #2, resource #4} that is a resource remaining after excluding {resource #3} corresponding to resource C from resource A but may not transmit {symbol #3} mapped to {resource #3} corresponding to resource C. Accordingly, the BS may map the symbol sequence {symbol #1, symbol #2, symbol #4} to {resource #1, resource #2, resource #4}, respectively, and may transmit the same.

The UE may determine resource A and resource B based on scheduling information associated with symbol sequence A obtained from the BS, and thus may determine resource C that is the area where resource A and resource B overlap. The UE may assume that symbol sequence A is mapped to the entire resource A and is only transmitted in the remaining area excluding resource C from the entire resource A, and may receive symbol sequence A. For example, when symbol sequence A is configured with {symbol #1, symbol #2, symbol #3, symbol #4}, resource A is {resource #1, resource #2, resource #3, resource #4}, and resource B is {resource #3, resource #5}, the UE may assume that symbol sequence A {symbol #1, symbol #2, symbol #3, symbol #4} is mapped to the resource A {resource #1, resource #2, resource #3, resource #4}, respectively, and {symbol #3} mapped to {resource #3} corresponding to resource C is not transmitted, and may assume that corresponding symbol sequence {symbol #1, symbol #2, symbol #4} is mapped to {resource #1, resource #2, resource #4} that is a resource remaining after excluding {resource #3} corresponding to resource C from resource A and is transmitted, and may perform reception. Accordingly, the UE may assume that the symbol sequence {symbol #1, symbol #2, symbol #4} is mapped to {resource #1, resource #2, resource #4}, respectively, and is transmitted, and may perform a series of subsequent reception operations.

Rate matching is performed to adjust the size of a signal in consideration of the amount of resource capable of transmitting the signal. For example, rate matching of a data channel is to adjust the size of data with respect to a predetermined time and frequency resource area, as opposed to mapping and transmitting the data channel.

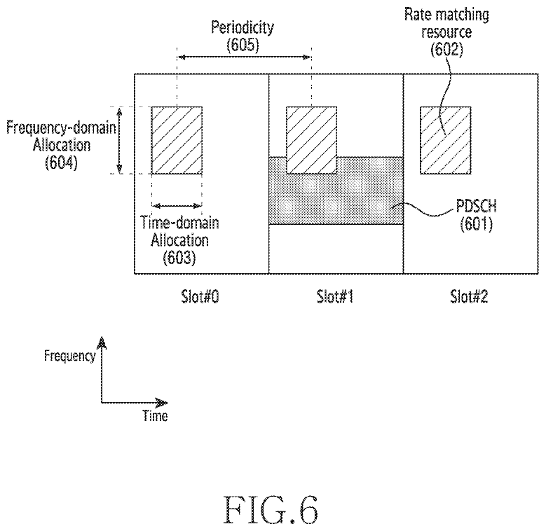

FIG. 6 illustrates a method of transmitting or receiving data in consideration of a DL data channel and a rate matching resource, by a BS and a UE, according to an embodiment.

In FIG. 6, a PDSCH 601 and a rate matching resource 602 are illustrated. The BS may configure one or multiple rate matching resources 602 via higher layer signaling (e.g., RRC signaling). In configuration information of the rate matching resource 602 may include time-domain resource allocation information 603, frequency-domain resource allocation information 604, and cycle information 605. Hereinafter, a bitmap corresponding to frequency-domain resource allocation information 604 is referred to as a first bitmap, a bitmap corresponding to time-domain resource allocation information 603 is referred to as a second bitmap, and a bitmap corresponding to cycle information 605 is referred to as a third bitmap. When the whole or a part of the time and frequency resource of the scheduled data channel 601 overlaps the configured rate matching resource 602, the BS may perform rate matching of the data channel 601 in the part of the rate matching resource 602 and may perform transmission. The UE may perform reception and decoding on the assumption that the data channel 601 is rate matched in the part of the rate matching resource 602.

Via an additional configuration, the BS may report whether to perform rate matching on a data channel in the configured rate matching resource part, to the UE dynamically via DCI (corresponding to a “rate matching indicator” in the above-described DCI format). Specifically, the BS may select some of the configured rate matching resources and may group them into a rate matching resource group, and may indicate whether to perform rate matching of a data channel for each rate matching resource group to the UE via DCI according to a bitmap scheme. For example, when 4 rate matching resources (RMR), that is, RMR #1, RMR #2, RMR #3, and RMR #4 are configured, the BS may configure rate matching groups such as rate matching group (RMG) #1={RMR #1, RMR #2} and RMG #2={RMR #3, RMR #4}, and may indicate whether to perform rate matching in each RMG #1 and RMG #2 to the UE via a bitmap by using 2 bits in a DCI field. For example, when rate matching needs to be performed, “1” is indicated, and otherwise, when rate matching is not needed, “O” is indicated.

In 5G, as a method of configurating a rate matching resource for a UE, granularity at an “RB symbol level” and granularity at an “RE level” may be supported. Particularly, the following configuration method may be used.

### At an RB Symbol Level

A maximum of four pieces of RateMatchPattern for each BWP may be configured for a UE via higher layer signaling, and a single piece of RateMatchPattern may include the following content.

As a reserved resource in a BWP, a time and frequency resource area of the corresponding reserved resource configured based on a combination of a bitmap at an RB level and a bitmap at a symbol level in the frequency axis may be included. The reserved resource may span one or two slots. A time domain pattern (periodicity AndPattern) in which a time and frequency resource area configured with a pair of a bitmap at an RB level and a bitmap at a symbol level is repeated may be additionally configured.

A time and frequency-domain resource area configured with a CORESET in a BWP, and a resource area corresponding to a time domain pattern configured based on a search space configuration in which the corresponding resource area is repeated may be included.

### At an RE Level

A UE may be configured with the following content via higher layer signaling.

As configuration information (lte-CRS-ToMatchAround) associated with an RE corresponding to an LTE cell-specific RS or common RS (LTE CRS) pattern, the number of ports of an LTE CRS (nrofCRS-Ports) and an LTE-CRS-vshift(s) value (v-shift), the location information (carrierFreqDL) of a center subcarrier of an LTE carrier based on a reference frequency point (e.g., reference point A), bandwidth size (carrierBandwidthDL) information of an LTE carrier, and subframe configuration information (mbsfn-SubframConfigList) corresponding to a multicast-broadcast single-frequency network (MBSFN), and the like may be included. Based on the above-described information, the UE may determine the location of a CRS in an NR slot corresponding to an LTE subframe.

Configuration information associated with a resource set corresponding to a single zero power (ZP) CSI-RS or multiple ZP CSI-RSs in a BWP may be included.

### PDSCH/PUSCH: Time Resource Allocation

A BS may configure a table associated with time domain resource allocation information for a PDSCH and a PUSCH for a UE via higher layer signaling (e.g., an RRC signaling). The BS may configure a table including a maximum of 16 entries (maxNrofDL-Allocations=16) in association with a PDSCH, and may configure a table including a maximum of 16 entries (maxNrofUL-Allocations=16) in association with a PUSCH. In an embodiment, the time domain resource allocation information may include a PDCCH-to-PDSCH slot timing (a slot unit-based time interval between the point in time at which a PDCCH is receive and the point in time at which a PDSCH, scheduled by the received PDCCH, is transmitted, and denoted by K0) or a PDCCH-to-PUSCH slot timing (a slot unit-based time interval between the point in time at which a PDCCH is received and the point in time at which a PUSCH, scheduled by the received PDCCH, is transmitted, and denoted by K2), information associated with the location of a start symbol where a PDSCH or a PUSCH is scheduled in a slot and the length of symbols, a PDSCH or PUSCH mapping type, and the like. For example, information such as shown below in Table 15 or Table 16 may be transmitted from the BS to the UE.

TABLE 15
PDSCH-TimeDomainResourceAllocationList information element

| | |
|---|---|
| PDSCH-TimeDomainResourceAllocationList ::= | SEQUENCE (SIZE(1..maxNrofDL-Allocations)) OF |

PDSCH-TimeDomainResourceAllocation

| | |
|---|---|
| PDSCH-TimeDomainResourceAllocation ::= | SEQUENCE { |
| k0 | INTEGER(0..32) |

OPTIONAL, -- Need S
(PDCCH-to-PDSCH Timing, slot unit )

| | |
|---|---|
| mappingType | ENUMERATED {typeA, typeB}, |

{PDSCH Mapping type}

| | |
|---|---|
| scartSymbolAndLength | INTEGER (0..127) |

{Start symbol and length of PDSCH}
}

TABLE 16
PUSCH-TimeDomainResourceAllocation information element

| | |
|---|---|
| PUSCH-TimeDomainResourceAllocationList ::= | SEQUENCE (SIZE(1..maxNrofUL-Allocations)) OF |

PUSCH-TimeDomainResourceAllocation

| | |
|---|---|
| PUSCH-TimeDomainResourceAllocation ::= | SEQUENCE { |
| k2 | INTEGER (0..32) OPTIONAL, -- Need S |

(PDCCH-to-PUSCH Timing, slot unit )

| | |
|---|---|
| mappingType | ENUMERATED {typeA, typeB}, |

{PUSCH Mapping type}

| | |
|---|---|
| startSymbolAndLength | INTEGER (0..127) |

{Start symbol and length of PUSCH}
}

The BS may inform the UE of one of the entries in the tables associated with the time domain resource allocation information via L1 signaling (e.g., DCI) (for example, via a ‘time domain resource allocation’ field in DCI). The UE may obtain the time domain resource allocation information associated with a PDSCH or PUSCH based on the DCI received from the BS.

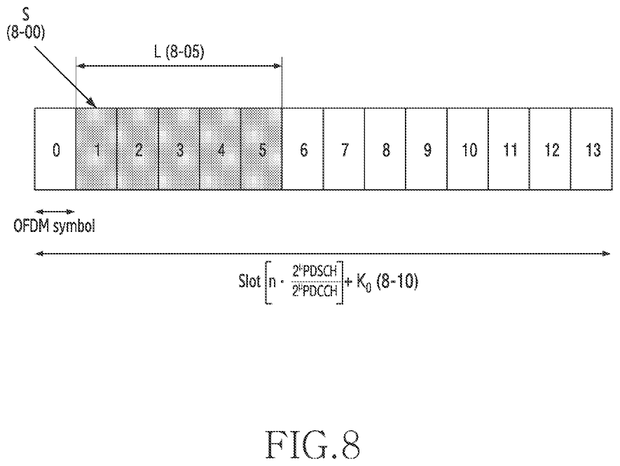

FIG. 8 illustrates time-domain resource allocation for a PDSCH in a wireless communication system according to an embodiment.

Referring to FIG. 8, a BS may indicate the location of a PDSCH resource in the time axis based on subcarrier spacings (SCS) (μPDSCH, μPDCCH) of a data channel and a control channel configured via higher layer, a scheduling offset (KO) value, and a start point 8-00 and a length 8-05 of OFDM symbols in a single slot dynamically indicated via DCI.

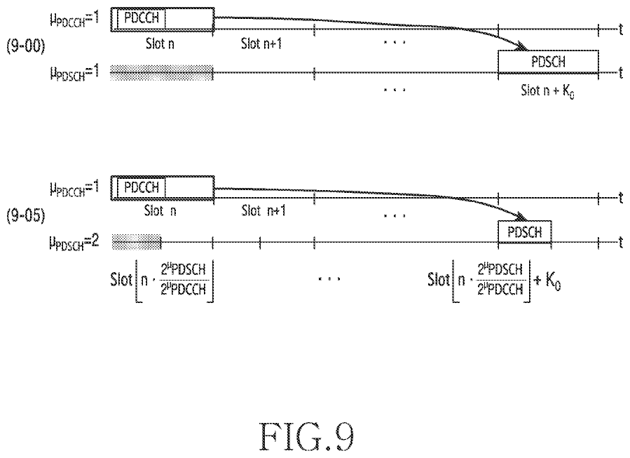

FIG. 9 illustrates time-domain resource allocation according to subcarrier spacings of a data channel and a control channel in a wireless communication system according to an embodiment.

Referring to FIG. 9, when the subcarrier spacing of a data channel and the subcarrier spacing of a control channel are the same (μPDSCH=μPDCCH) as shown in diagram 9-00, slot numbers for data and control are the same. Accordingly, a BS and a UE may produce a scheduling offset based on a predetermined slot offset K0. Conversely, when the subcarrier spacing of a data channel and the subcarrier spacing of a control channel are different (μPDSCH≠μPDCCH) as shown in diagram 9-05, slot numbers for data and control are different. Accordingly, a BS and a UE may produce a scheduling offset based on a predetermined slot offset K0 with reference to a subcarrier spacing of a PDCCH.

### PDSCH: Frequency Resource Allocation

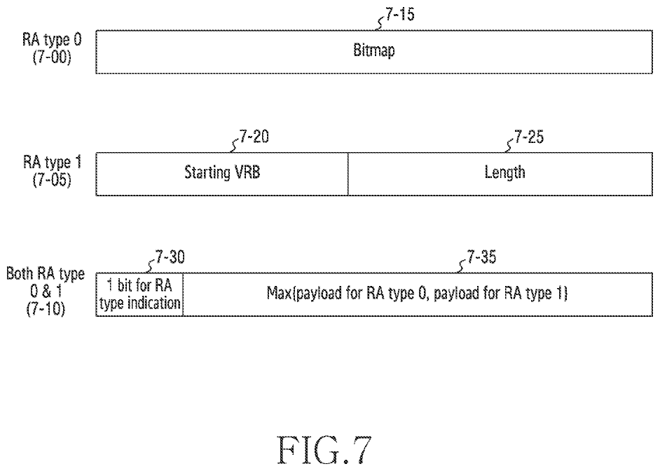

FIG. 7 illustrates frequency-domain resource allocation for a PDSCH in a wireless communication system according to an embodiment.

FIG. 7 is a diagram illustrating three types of frequency-domain resource allocation methods, that is, type 0 7-00, type 1 7-05, and dynamic switch 7-10 which are configurable via a higher layer in an NR wireless communication system.

Referring to FIG. 7, when a UE is configured via higher layer signaling, so as to use only resource type 0 as shown in diagram 7-00, some DCI that allocates a PDSCH for the corresponding UE may include a bitmap configured with NRBG bits. The condition for the above will be described later. In this instance, NRBG is the number of resource block groups (RBG) determined based on a BWP size allocated by a BWP indicator and a higher layer parameter rbg-Size, as shown below in Table 17, and data is transmitted in an RBG denoted by 1 in a bitmap.

TABLE 17

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

When a UE is configured via higher layer signaling, so as to use only resource type 1 as shown in diagram 7-05, some DCI that allocates a PDSCH to the corresponding UE may include frequency-domain resource allocation information including ┌log₂ (N_{RB}^{DL,BWP} (N_{RB}^{DL,BWP}+1)/2┐ bits. The condition for the above will be described later. Based on the same, a BS may configure a starting VRB 7-20 and the length 7-25 of a frequency-domain resource consecutively allocated from the starting VRB 7-20.

When a UE is configured via higher layer signaling, so as to use both resource type 0 and resource type 1 as shown in diagram 7-10, some DCI that allocates a PDSCH to the corresponding UE may include frequency-domain resource allocation information configured with bits of a payload having a higher value 7-35 among a payload 7-15 for configuring resource type 0 and a payload 7-20 and 7-25 for configuring resource type 1. The condition for the above will be described later. In this instance, one bit may be added to the most significant bit (MSB) of the frequency-domain resource allocation information in the DCI. When the corresponding bit is ‘0’, this may indicate that resource type 0 is to be used, and when the corresponding bit is ‘1’, this may indicate that resource type 1 is to be used.

PDSCH: phase tracking RS (PTRS) When receiving a PDSCH from a BS, a UE may receive a PTRS for tracking a phase associated with a DL channel. For the UE, phaseTrackingRS that is a higher layer signaling parameter for a PTRS may be configured in DMRS-DownlinkConfig that is a higher layer signaling parameter. When phaseTrackingRS is configured for the UE by the BS via a higher signaling parameter, a resource in which a PTRS is transmitted in the frequency domain and the time domain may be configured via frequencyDensity and timeDensity. In the case of the UE, frequencyDensity in PTRS-DownlinkConfig that is a higher layer signaling parameter may indicate NRB0 or NRB1, and timeDensity may indicate ptrs-MCS1 or ptrs-MCS3.

The UE may determine PTRS density in the time domain (LPT-RS) and PTRS density (KPT-RS) in the frequency domain according to the MCS (IMCS) and the NRB of a scheduled PDSCH, as shown below in Table 18 and 19. In Table 18 shown below, although ptrs-MCS4 is not mentioned as a higher layer parameter, a BS and a UE may be aware that it is 29 or 28 according to the configured MCS table. In Table 19 shown below, an NRB is the number of RBs scheduled for a PDSCH.

TABLE 18

| Scheduled MCS | Time Density (L_{PT-RS}) |
|---|---|
| I_{MCS} < ptrs-MCS₁ | PT-RS is not present |
| ptrs-MCS₁ ≤ I_{MCS} < ptrs-MCS₂ | 4 |
| ptrs-MCS₂ ≤ I_{MCS} < ptrs-MCS₃ | 2 |
| ptrs-MCS₃ ≤ I_{MCS} < ptrs-MCS₄ | 1 |

TABLE 19

| Scheduled bandwidth | Frequency density (K_{PT-RS}) |
|---|---|
| N_{RB} < N_{RB0} | PT-RS is not present |
| N_{RB0} ≤ NRB < N_{RB1} | 2 |
| N_{RB1} ≤ NRB | 4 |

A DMRS configured by the BS and an associated PTRS may be mapped to the same subcarrier location, and the same precoding may be assumed for the antenna ports of the DMRS and PTRS. For the UE, a single PTRS antenna port is defined for reception of a PTRS, and the PTRS antenna port may be associated with a DMRS antenna port based on a codeword. When a single codeword is transmitted, a PTRS antenna port may be associated with a DMRS antenna port having the lowest index, and when two codewords are transmitted, the PTRS antenna port may be associated with a DMRS antenna port having the lowest index for a scheduled codeword with a higher MCS.

### PRB Bundling

A BS may determine the configuration of a precoding granularity in the frequency domain for a UE in units of consecutive resource blocks, that is, based on a PRB bundling size unit P_{BWP,i}′. When the PRB bundling size P_{BWP,i}′ is determined to be a “wideband”, the UE may not expect nonconsecutive PRB scheduling and the UE may apply the assumption of the same precoding, TCI state or QCL to the allocated frequency resource. When P_{BWP,i}′ is determined to be one of {2, 4}, an ith BWP may be configured with a PRG including as many consecutive PRBs as P_{BWP,i}′. In this instance, the actual number of consecutive PRBs included in the PRG with respect to the start point and the end point of a BWP may be less than a PRG size P_{BWP,i}′. That is, the size of the BWP in the frequency domain may not be divided evenly by the PRG size. Therefore, the PRG at the start point of the BWP may be configured with P_{BWP,i}′−N_{BWP,i}^{start} mod P_{BWP,i}′ PRBs. In association with the size of a PRG at the end point of the BWP, when (N_{BWP,i}^{start}+N_{BWP,i}^{size})mod P_{BWP,i}′ is greater than 0, the size of the PRG may be determined to be (N_{BWP,i}^{start}+N_{BWP,i}^{size})mod P_{BWP,i}′. When (N_{BWP,i}^{start}+N_{BWP,i}^{size})mod P_{BWP,i}′ is 0, the size of the PRG may be determined to be P_{BWP,i}′. In this instance, the UE may assume that the same precoding is applied to consecutive DL PRBs in the PRG.

Based on configuration and/or indication information from the BS, the UE may determine a PRG size P_{BWP,i}′. When the BS schedules a PDSCH for the UE via DCI format 1_0 or DCI format 4_0, the UE may assume that the PRG size P_{BWP,i}′ is 2. When prb-BundlingType in higher layer signaling information PDSCH-Config from the BS is not configured for the UE, and a PDSCH is scheduled via DCI format 1_1, the UE may assume that the PRG size P_{BWP,i}′ is 2. When prb-BundlingType in higher layer signaling information PDSCH-Config from the BS is configured as ‘staticBundling’ for the UE, the UE may determine a single value indicated by bundliSzie in the higher layer signaling information PDSCH-Config as the PRG size P_{BWP,i}′.

When prb-BundlingType in the higher layer signaling information PDSCH-Config from the BS is configured as ‘dynamicBundling’ for the UE, bundleSizeSet 1 and bundleSizeSet2 in the higher layer signaling information PDSCH-Config may be configured for the UE and the PRG size P_{BWP,i}′ included in each bundleSizeSet may have one or two values among {2, 4, wideband}. A method in which the UE receives an indication associated with a PRG size from the BS via DCI format 1_1 may be as follows. When ‘bundling size indicator’ in DCI format 1_1 from the BS indicates 0 to the UE, the UE may receive a PDSCH by applying P_{BWP,i}′ via a second set (bundleSizeSet2) among sets of PRG size P_{BWP,i}′ (i.e., bundleSizeSet1 and bundleSizeSet2). When ‘bundling size indicator’ in DCI format 1_1 from the BS indicates 1 to the UE, the UE may perform reception by applying P_{BWP,i}′ via bundleSizeSet1. In this instance, a combination included in bundleSizeSet1 may be present, and the combination may differ according to the following situation.

When the size of bundleSizeSet1 is 1 (i.e., the number of values included in bundleSizeSet1 is 1), n4 or a wideband may be configured in bundleSizeSet1.

When the size of bundleSizeSet1 is 2 (i.e., the number of values included in bundleSizeSet1 is 2), {n2-wideband} or {n4-wideband} may be configured in bundleSizeSet1.

When consecutive PRBs are scheduled, and a PRB that is scheduled is greater than N_{BWP}^{size}/2, the number of scheduled RBs, that is, a wideband, may be applied. Otherwise, 2 or 4 may be applied.

### CA/DC

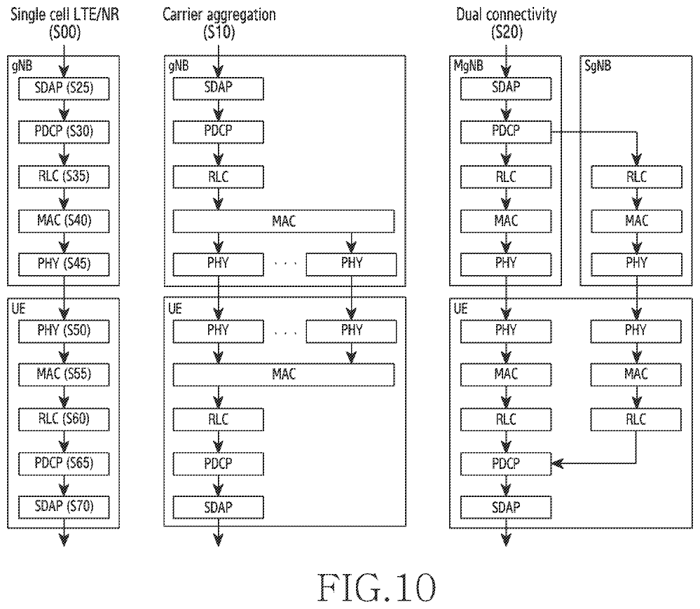

FIG. 10 illustrates the radio protocol structures of a BS and a UE in a single cell case, a carrier aggregation case, and a dual connectivity case according to an embodiment.

Referring to FIG. 10, a radio protocol of the next generation mobile communication system may include an NR service data adaptation protocol (NR SDAP) S25 and S70, an NR packet data convergence protocol (NR PDCP) S30 and S65, an NR radio link control (NR RLC) S35 and S60, and an NR medium access control (NR MAC) S40 and S55, for each of a UE and an NR BS.

The main function of the NR SDAP S25 and S70 may include transfer of user plane data, mapping between a QoS flow and a DRB for both DL and UL and marking a QoS flow ID in both DL and UL packets.

### Reflective QoS Flow to DRB Mapping for UL SDAP PDUs

In association with an SDAP layer device, whether to use the header of the SDAP layer device or whether to use the function of the SDAP layer device may be configured for the UE via an RRC message for each PDCP layer device, for each bearer, or for each logical channel. When the SDAP header is configured, a NAS reflective QoS configuration one-bit indicator (NAS reflective QoS) and an AS reflective QoS configuration one-bit indicator (AS reflective QoS) of the SDAP header may provide an indication so that the UE updates or reconfigures mapping information between a QoS flow and a data bearer in a UL and a DL. The SDAP header may include QoS flow ID information indicating QoS. The QoS information may be used as data processing priority information, scheduling information, or the like for supporting a smooth service.

The main functions of the NR PDCP S30 and S65 may include at least one of: ROHC only, transfer of user data, sequential transfer (in-sequence delivery of upper layer PDUs), non-sequential transfer (out-of-sequence delivery of upper layer PDUs), reordering (PDCP PDU reordering for reception), duplicate detection of lower layer SDUs, retransmission of PDCP SDUs, ciphering and deciphering, and timer-based SDU discard in the UL.

The mentioned reordering function of the NR PDCP device is sequentially reordering PDCP PDUs received in a lower layer according to a PDCP sequence number (PDCP SN), and may include transferring data to a higher layer in a reordered sequence. The reordering function of the NR PDCP device may include immediately transferring data irrespective of a sequence, recording lost PDCP PDUs after sequential reordering, reporting the states of lost PDCP PDUs to a transmission side, and requesting retransmission of lost PDCP PDUs.

The main function of the NR RLC S35 and S60 may include at least one of transfer of upper layer PDUs, sequential transfer (in-sequence delivery of upper layer PDUs), non-sequential transfer (out-of-sequence delivery of upper layer PDUs), error correction through ARQ, concatenation, segmentation, and reassembly of RLC SDUs, re-segmentation of RLC data PDUs, reordering of RLC data PDUs, duplicate detection, protocol error detection, RLC SDU discard, and RLC re-establishment.

The mentioned in-sequence delivery function of the NR RLC device is sequentially transferring RLC SDUs, received from a lower layer, to a higher layer. In when a single original RLC SDU is divided into multiple RLC SDUs and the multiple RLC SDUs are received, the in-sequence delivery function of the NR RLC may include reassembling and transmitting the same. The in-sequence delivery function of the NR RLC device may include reordering received RLC PDUs according to an RLC sequence number (RLC SN) or a PDCP sequence number (PDCP SN), and recording lost RLC PDUs after sequential reordering, reporting the states of the lost RLC PDUs to a transmission side, and requesting retransmission of the lost RLC PDUs. The in-sequence delivery function of the NR RLC device may include sequentially transferring, to a higher layer, only RLC SDUs before a lost RLC SDU when there is a lost RLC SDU. Even though there is a lost RLC SDU, when a predetermined timer expires, the in-sequence delivery function may include sequentially transferring RLC SDUs, received before the timer starts, to a higher layer. Alternatively, the in-sequence delivery function of the NR RLC device may include sequentially transferring all RLC SDUs, received up to the present, to a higher layer even though there is a lost RLC SDU, when a predetermined timer expires. In addition, RLC PDUs are processed in order of reception (in order of arrival, irrespective of a serial number or a sequence number), and are transmitted to the PDCP device irrespective of a sequence (out-of-sequence delivery). In the case of segments, segments, which are stored in a buffer or which are to be received in the future, are received and reconfigured as a single intact RLC PDU, are processed, and are transmitted to the PDCP device. The NR RLC layer may not include a concatenation function, or may perform the function in the NR MAC layer or replace the function with a multiplexing function in the NR MAC layer.

The out-of-sequence delivery function of the NR RLC device is immediately transferring RLC SDUs, received from a lower layer, to a higher layer irrespective of a sequence. When a single original RLC SDU is divided into multiple RLC SDUs and the multiple RLC SDUs are received, the out-of-sequence delivery function may include reassembling and transmitting the same, and storing the RLC SN or PDCP SN of the received RLC PDUs, and performing sequential ordering, and recording lost RLC PDUs.

The NR MAC S40 and S55 may be connected to multiple NR RLC layer devices configured for a single UE, and the main functions of the NR MAC may include at least one of mapping between logical channels and transport channels, multiplexing and demultiplexing of MAC SDUs, scheduling information reporting, error correcting through HARQ, priority handling between logical channels of one UE, priority handling between UEs by dynamic scheduling, MBMS service identification, transport format selection, and padding.

The NR PHY layer S45 and S50 may perform channel-coding and modulating of higher layer data to produce an OFDM symbol, and transmit the OFDM symbol via a wireless channel, or may perform demodulating and channel-decoding of the OFDM symbol, received via a wireless channel, and transmit the demodulated and channel-decoded OFDM symbol to a higher layer.

The detailed structure of the radio protocol structure may be variously changed depending on a carrier (or cell) operation scheme. For example, when a BS transmits, based on a single carrier (or cell), data to a UE, the BS and the UE may use a protocol structure having a single structure for each layer as shown in diagram S00. Conversely, when, based on CA that uses multiple carriers in a single transmission and reception point (TRP), a BS transmits data to a UE, the BS and the UE may use a protocol structure that has a single structure up to RLC and performs multiplexing a PHY layer via a MAC layer, as shown in diagram S10. As another example, when, based on dual connectivity (DC) that uses multiple carriers in multiple TRPs, a BS transmits data to a UE, the BS and the UE may use a protocol structure that has a single structure up to RLC but performs multiplexing a PHY layer via a MAC layer, as shown in diagram S20.

Referring to the above-described PDCCH and the description related to configuration of a beam, repetitive PDCCH transmission is not supported in Release (Rel)-15 and Rel-16 NR currently, and thus it is difficult to obtain request reliability in a scenario that needs high-reliability such as URLLC and the like. The disclosure provides a repetitive PDCCH transmission method via multiple transmission points (TRP) so as to improve a PDCCH reception reliability of a UE. A method will be described in detail in the following embodiments.

Hereinafter, embodiments of the disclosure will be described in detail with reference to the accompanying drawings. The content provided in the disclosure may be applicable in FDD and TDD systems. Hereinafter, higher signaling (or higher layer signaling) is signal transferring from a BS to a UE via a DL data channel of a physical layer, or signal transferring from a UE to a BS via a UL data channel of a physical layer, which may also be referred to as RRC signaling, PDCP signaling, or MAC control element (CE).

Herein, when determining whether cooperative communication is applied, a UE may use various methods such as a method in which a PDCCH(s) that allocates a PDSCH to which cooperative communication is applied has a predetermined format, a method in which a PDCCH(s) that allocates a PDSCH to which cooperative communication is applied includes a predetermined indicator indicating whether cooperative communication is applied, a method in which a PDCCH(s) that allocates a PDSCH to which cooperative communication is applied is scrambled by a predetermined RNTI, a method in which application of cooperative communication is assumed in a predetermined interval indicated via a higher layer, or the like. For ease of description, when a UE receives a PDSCH to which cooperative communication is applied based on the conditions similar to the above is referred to as an NC-JT case.

Herein, determining priorities of A and B may be variously described such as the case of selecting one having a higher priority according to a predetermined priority rule and performing an operation corresponding thereto, or the case of omitting or dropping one that has a lower priority, or the like.

Although the disclosure describes the various examples via a plurality of embodiments, the embodiments are not independent from one another but one or more embodiments may be applicable together or in parallel.

### SBFD

In 3GPP, SBFD has been discussed as a new duplex scheme based on NR. In a TDD band (spectrum) of 6 GHz or lower frequency or 6 GHz or higher frequency, SBFD may receive, from a UE, as much UL transmission as a UL resource increased by utilizing some of a DL resource as a UL resource, may extend UL coverage of the UE, and may receive, from the UE, feedback with respect to DL transmission in the extended UL resource, so as to reduce a feedback delay. In the disclosure, a UE that is capable of receiving, from a BS, information associated with whether SBFD is supported, and performing UL transmission in a part of a DL resource (or a UE that has related capability and is capable of reporting capability to a BS) is referred to as an SBFD UE (SBFD-capable UE). To define the SBFD scheme in the standard, and to enable an SBFD UE to determine that the SBFD is supported in a predetermine cell (or frequency, frequency band), the following scheme may be considered.

In a first scheme, in addition to an existing frame structure type of an unpaired spectrum (or time division duplex (TDD)) or a paired spectrum (or frequency division duplex (FDD)), another frequency structure type (e.g., frame structure type 2) may be introduced to define the SBFD. Fame structure type 2 may define that SBFD is supported in the predetermined frequency or frequency band, or a BS may indicate whether SBFD is supported to a UE via system information. An SBFD UE may receive system information including whether the SBFD is supported and may determine whether SBFD is supported in the predetermined cell (or frequency, frequency band).

In a second scheme, without defining a new frame structure type, whether the SBFD is additionally supported in a predetermined frequency or frequency band of an existing unpaired spectrum (or TDD) may be indicated. In the second scheme, whether the SBFD is additionally supported in a predetermined frequency or frequency band of an existing unpaired spectrum may be defined, or a BS may indicate whether SBFD is supported to a UE via system information. An SBFD UE may receive system information including whether the SBFD is supported and may determine whether SBFD is supported in the predetermined cell (or frequency, frequency band).

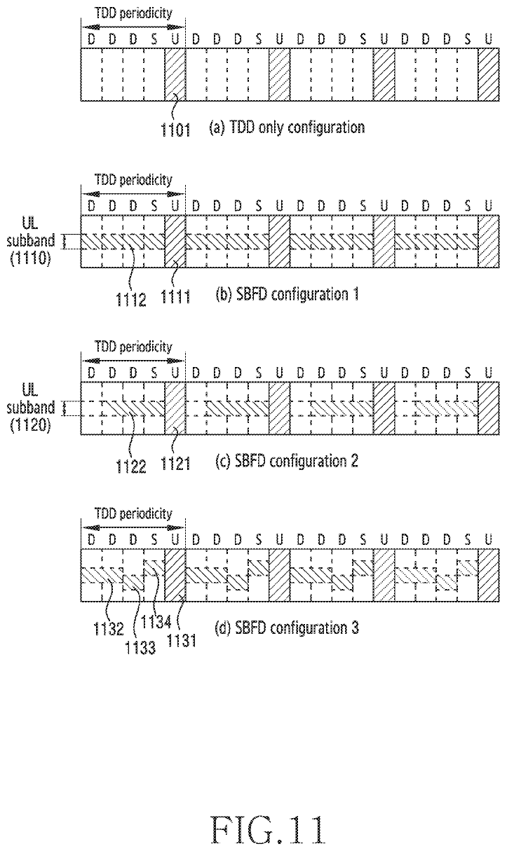

In the first and second schemes, information associated with whether SBFD is supported may be information (e.g., SBFD resource configuration information to be described in FIG. 11) indirectly (or implicitly) indicating whether SBFD is supported by configuring a part of a DL resource as a UL resource, or may be information directly (or explicitly) indicating whether SBFD is supported, in addition to a configuration associated with TDD UL-DL resource configuration information indicating a DL slot (or symbol) resource and UL slot (or symbol) resource of TDD.

The SBFD UE may receive an SS block (i.e., an SS/PBCH block) and may obtain cell synchronization at an initial cell access for accessing a cell (or BS). The process of obtaining the cell synchronization may be identical between an SBFD UE and an existing TDD UE (or SBFD-incapable UE). Subsequently, the SBFD UE may determine whether the cell supports SBFD by obtaining an MIB or SIB or via a random access process.

System information to transmit information associated with whether the SBFD is supported may be system information that is distinguished from system information for a UE (e.g., an existing TDD UE) that supports a different version of standard in the cell, and is transmitted separately. The SBFD UE may determine the whole or part of the system information that is separately transmitted from the system information of the existing TDD UE, and may determine whether SBFD is supported in the corresponding cell. When the SBFD UE obtains only system information for the existing TDD UE or obtains system information indicating that SBFD is not supported, the SBFD UE may determine that the cell (or BS) supports only TDD.

When information associated with whether SBFD is supported is included in system information for a UE (e.g., an existing TDD UE) that supports a different version of standard, the information associated with whether the SBFD is supported may be inserted into the last portion of the system information so as not to affect obtaining of the system information of the existing TDD UE. When the SBFD UE fails to obtain information associated with whether SBFD is supported, which is inserted into the last portion, or obtains information indicating that SBFD is not supported, the SBFD UE may determine that the cell (or BS) supports only TDD.

When information associated with whether SBFD is supported is included in system information for a UE (e.g., an existing TDD UE) that supports a different version of standard, the information associated with whether the SBFD is supported may be transmitted via a separate PDSCH so as not to affect obtaining of the system information of the existing TDD UE. That is, an SBFD-incapable UE may receive a first SIB including existing TDD-related system information via a first PDSCH. An SBFD-capable UE may receive a first SIB including existing TDD-related system information via a first PDSCH, and may receive a second SIB including SBFD-related system information via a second PDSCH different from the first PDSCH. The first PDSCH and the second PDSCH may be scheduled via a first PDCCH and a second PDCCH, respectively, and cyclic redundancy codes (CRC) of the first PDCCH and the second PDCCH may be scrambled by the same RNTI (e.g., SI-RNTI). A search space for monitoring the second PDCCH may be obtained from the system information of the first PDSCH. When the UE does not obtain information associated with a search space for monitoring the second PDCCH from the system information of the first PDSCH (i.e., when the system information of the first PDSCH does not include information associated with the search space), the UE may receive the second PDCCH in a search space that is the same as the search space of the first PDCCH.

When the SBFD UE determines that the cell (or BS) supports only TDD, the SBFD UE may perform a random access procedure and data/control signal transmission or reception in the same manner as that of the existing TDD UE.

The BS may configure a random access resource separately for each of an existing TDD UE or an SBFD UE (e.g., an SBFD UE that supports duplex communication and an SBFD UE that supports half-duplex communication), and may transmit configuration information (control information or configuration information indicating a time-frequency resource usable for a PRACH) of the random access resource to the SBFD UE via system information. The system information to transmit information associated with the random access resource may be system information that is distinguished from system information for a UE (e.g., an existing TDD UE) that supports a different version of standard in the cell, and is transmitted separately.

The BS configures random access resources separately for the SBFD UE and the TDD UE that supports a different version of standard, and may distinguish whether the one that performs random access is the TDD UE that supports the different version of standard performs random access or the SBFD UE. For example, the random access resource separately configured for the SBFD UE may be a resource that the existing TDD UE identifies as a DL time resource, and the SBFD UE may perform random access via a UL resource (or a separate random access resource) configured in a part of the frequency of the DL time resource and the BS determines that a UE that attempts random access in the UL resource is the SBFD UE.

Alternatively, the BS may not configure a random access resource separately for the SBFD UE, but may configure a random access resource in common for all UEs in a cell. In this instance, configuration information for the random access resource may be transmitted to all UEs in the cell via system information, and an SBFD UE that receives the system information may perform random access in the random access resource. Subsequently, the SBFD UE may complete the random access process and may proceed with an RRC connection mode for performing data transmission or reception with a cell. After RRC connection mode, the SBFD UE may receive, from the BS, a higher or physical signal that enables determining that a part of the frequency resource of the DL time resource is configured as a UL resource, and may perform an operation related to SBFD (e.g., transmission of a UL signal in the UL resource).

When the SBFD UE determines that the cell supports SBFD, the SBFD UE may inform the BS that a UE that attempts accessing is an SBFD UE by transmitting capability information including at least one piece of information among information associated with whether the UE supports SBFD, information associated with whether full-duplex communication or half-duplex communication is supported, the number of transmission antennas that the UE is equipped with (or supports), or the number of reception antennas that the UE is equipped with (or supports). Alternatively, when supporting half-duplex communication is essential for the SBFD UE, whether the half-duplex communication is supported may be omitted from the capability information. In association with reporting of the capability information by the SBFD UE, the capability information may be reported to the BS via a random access process, may be reported to the BS after the random access process is completed, or may be reported to the BS after RRC access mode for data transmission or reception with a cell is performed.

The SBFD UE may support half-duplex communication that performs only UL transmission or DL reception at one instance in the same manner as the existing TDD UE or may support full-duplex communication that performs both UL transmission and DL reception at one instance. Therefore, whether half-duplex communication or full-duplex communication is supported may be reported by the SBFD UE to the BS via capability reporting, and after reporting, the BS may configure, for the SBFD UE, whether the half-duplex communication or the full-duplex communication is to be used when the SBFD UE performs transmission or reception. When the SBFD UE reports, to the BS, capability associated with the half-duplex communication, a switching gap for changing an RF between transmission and reception may be needed when operation is performed in FDD or TDD, since a duplexer is not present in general.

FIG. 11 is a diagram illustrating an example in which SBFD operates in a TDD band of a wireless communication system according to an embodiment.

Part (a) In FIG. 11 illustrates when TDD operates in a predetermined frequency band. Based on a configuration associated with TDD UL-DL resource configuration information indicating a DL slot (or symbol) resource and a UL slot (or symbol) resource of TDD, a BS in a cell that operates TDD may perform signal transmission or reception including data/control information with an existing TDD UE or an SBFD UE in a DL slot (or symbol), a UL slot (or symbol) 1101, or a flexible slot (or symbol).

In part (a) in FIG. 11, it is assumed that a DDDSU slot format is configured based on TDD UL-DL resource configuration information. ‘D’ denotes a slot configured with all DL symbols. ‘U’ denotes a slot configured with all UL symbols. ‘S’ is a slot that is different from ‘D’ or ‘U’, that is, a slot including a DL symbol or a UL symbol or including a flexible symbol. For ease of description, it is assumed that S is configured with 12 DL symbols and 2 flexible symbols. A DDDSU slot format may be repeated according to TDD UL-DL resource configuration information. That is, a repetition cycle of a TDD configuration may be 5 slots (5 ms in the case of 15 kHz SCS, 2.5 ms in the case of 30 kHz SCS, and the like).

In part (b) in FIG. 11, for a UE, a part of the frequency band of a cell may be configured as a frequency band 1110 in which UL transmission is available. This band may be referred to as a UL subband. The UL subband may be applied to all symbols of all slots. The UE may transmit an UL channel or signal scheduled in the UL subband in all symbols 1112. However, the UE may be incapable of transmitting a UL channel or signal in a band other than the UL subband.

In part (c) in FIG. 11, for a UE, a part of the frequency band of a cell may be configured as a frequency band 1120 in which UL transmission is available, and a time domain in which the frequency band is activated may be configured. This frequency band may be referred to as a UL subband. In FIG. 11C, a UL subband may be deactivated in a first slot, and a UL subband may be activated in the remaining slots. Therefore, the UE may transmit a UL channel or signal in a UL subband 1122 in the remaining slots where the UL subband is activated. In part (c) in FIG. 11, although a UL subband is activated in units of slots, whether to activate/deactivate a UL subband may be configured in a unit of a symbol included in a slot.

In part (d) in FIG. 11, a time-frequency resource in which UL transmission is available may be configured for a UE. The UE may be configured with one or more pieces of time-frequency resources as a time-frequency resource in which UL transmission is available. For example, a partial frequency band 1132 of a first slot and a second slot may be configured as a time-frequency resource in which UL transmission is available. In addition, a partial frequency band 1133 of a third slot and a partial frequency band 1134 of a fourth slot may be configured as a time-frequency resource in which UL transmission is available.

Herein, a time-frequency resource in which UL transmission is available in a DL symbol or slot may be referred to as an SBFD resource. A symbol in which a UL subband is configured in DL symbols may be referred to as an SBFD symbol. A time-frequency resource in which DL reception is available in a UL symbol or slot may be referred to as an SBFD resource. A symbol in which a DL subband is configured in UL symbols may be referred to as an SBFD symbol.

For ease of description, a band that excludes a UL subband, and in which a DL channel or signal is capable of being received may be expressed as a DL subband. For the UE, a maximum of a single UL subband may be configurable and a maximum of two DL subbands may be configurable in a single symbol. For example, the UE may be configured with one of UL subband and DL subband, DL subband and UL subband, or first DL subband, UL subband, and second DL subband, in the frequency domain.

A PRG grid used for a UE to receive a PDSCH may be determined based on the start point and the size of a DL BWP and PRB bundling related configuration information that the UE receives from a BS. In this instance, the UE may need to determine an RPG grid in an SBFD symbol/slot in which a UL subband is present, as well as in the DL only symbol/slot. Since a UL subband is present in an SBFD symbol/slot, a PRG may not be divided evenly by a configured PRB size in the frequency resource area excluding the start point and the end point of a DL BWP, which is a drawback.

The BS may transmit, to the UE, information for configuring a frequency density related to PTRS transmission, and the frequency density of a PTRS may be determined based on the size of a scheduled PRB. However, in an SBFD symbol/slot, a DL frequency resource that is a UL subband less than that of a DL only symbol/slot may be used, and thus the size of a scheduled PRB that is actually used may be different. When the size of a scheduled PRB in the SBFD symbol/slot is interpreted to be the same as that in the DL only symbol/slot, the frequency density of the PTRS may be determined to be inappropriate for the SBFD symbol/slot.

Thus, disclosed herein is a method of determining a PRG grid in consideration of a UL subband, determining the size of a scheduled PRB in an SBFD symbol/slot, interpreting a DL BWP size, and assuming precoding when wideband PRB bundling is configured, and the like.

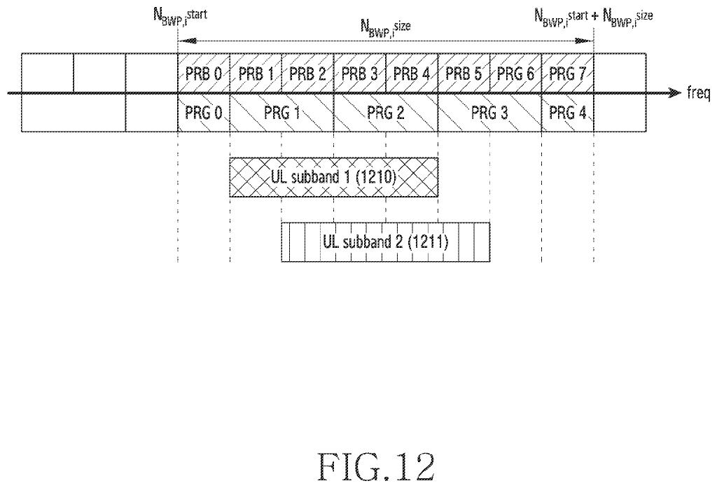

FIG. 12 illustrates a method of determining a PRG grid for a scheduled PRB according to an embodiment.

Referring to FIG. 12, a UE may receive a DL BWP configuration from a BS via higher layer configuration information, and the DL BWP configuration may configure the start point N_{BWP,i}^{start} of a BWP and the size N_{BWP,i}^{size} of a BWP in units of PRBs. In FIG. 12, the DL BWP configuration that the BS transmits to the UE may indicate and N_{BWP,i}^{start}=71 and N_{BWP,i}^{size}=8. Accordingly, the UE and the BS may determine the end point of the BWP to be N_{BWP,i}^{start}+N_{BWP,i}^{size}=79 The UE and the BS may determine a PRG grid based on a PRB bundling size (i.e., PRB bundling granularity) configured based on the above-described BWP configuration and UL layer configuration information, and the example of FIG. 12 illustrates when a PRB bundling size is set to 2. Via the configuration information, a PRG grid between the UE and the BS may be configured based on each two PRBs, and the start point of a BWP that is not divided evenly by the PRB bundling size may be determined to be P_{BWP,i}′−N_{BWP,i}^{start} mod P_{BWP,i}′, and the end point may be determined to be (N_{BWP,i}^{start}+N_{BWP,i}^{size})mod P_{BWP,i}′.

When the SBFD system considers a UL subband, there may be ambiguity in performing a PRG grid determination method. For example, when a frequency resource of a UL subband is configured to be aligned with the start point of the existing PRG 1 and the end point of PRG 2 as shown in the case of UL subband 1 1210 (i.e., when the start point or the end point of the UL subband frequency resource are aligned with the boundary between different PRGs included in a PRG grid), there may be no problem occurring in the PRG grid determination method. However, when a UL subband frequency resource is configured as shown in the case of UL subband 2 1211 that is not aligned with an existing PRG grid (i.e., when the start point or end point of the UL subband frequency resource is not aligned with the boundary between different PRGs included in a PRG grid), there may be ambiguity when the UE and the BS determine a PRG grid. In the following embodiments, there may be provided methods to overcome the drawback.

### First Embodiment: A Method of Determining Whether a UL Subband is Aligned with a PRG Grid when Configuring a UL Subband

A UE may determine a PRG grid in consideration of a UL subband by performing a modulo operation based on a UL subband frequency resource configuration received from a BS. The UE may receive configuration information related to a BWP and PRB bundling size from the BS via higher layer configuration information. In an SBFD system, the UE may receive configuration information associated with a UL subband frequency resource separately. In this instance, to determine a PRG grid, the UE may perform a modulo operation based on the received UL subband frequency resource configuration information.

A detailed method in which a UE determines a PRG grid by using UL subband frequency resource configuration information received from a BS may be as follows. When the result value of a modulo operation that the UE performs on the start point of a UL subband and a PRB bundling size is 0 (e.g., N_{ULSB}^{start} mod P_{BWP,i}′) and the result value of a modulo operation performed on the end point of the UL subband and the PRB bundling size is 0 (e.g., (N_{ULSB}^{start}+N_{ULSB}^{size})mod P_{BWP,i}′=0), the UE may determine that the frequency resource of the UL subband is aligned with a PRG grid. When the result value of a modulo operation that the UE performs on the start point of the UL subband and the PRB bundling size is not 0 (e.g., N_{ULSB}^{start} mod P_{BWP,i}′≠0) and the result value of a modulo operation performed on the start point and the end point of the UL subband and the PRB bundling size is not 0 (e.g., (N_{ULSB}^{start}+N_{ULSB}^{size})mod P_{BWP,i}′≠0), the UE may determine that the frequency resource of the UL subband is not aligned with a PRG grid.

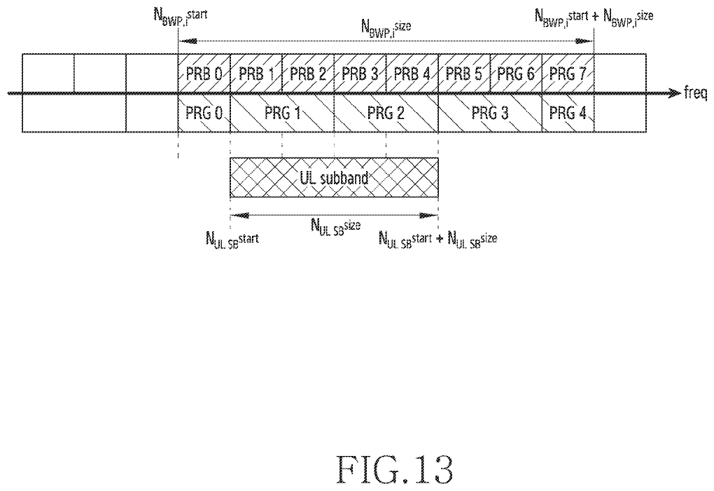

FIG. 13 illustrates a method of configuring a UL subband frequency resource that is aligned with a PRG grid according to an embodiment.

Referring to FIG. 13, a UE may receive higher layer configuration information from a BS. Higher layer configuration information that the UE receives from the BS may include a DL BWP configuration, and for example, information for configurating a DL BWP may indicate the start point N_{BWP,i}^{start} of the BWP and the size N_{BWP,i}^{size} of the BWP in units of PRBs. In FIG. 13, the DL BWP configuration that the UE receives indicates N_{BWP,i}^{start}=71 and N_{BWP,i}^{size}=8, and the UE may identify the end point of the BWP as N_{BWP,i}^{start}+N_{BWP,i}^{size}=79. The UE may determine a PRG grid based on a PRB bundling size (e.g., PRB bundling granularity) configured based on the BWP configuration and higher layer configuration information received from the BS. In FIG. 13, it is assumed that a PRB bundling size is set to 2. In addition, the higher layer configuration information that the BS transmits to the UE may include configuration information associated with a UL subband frequency resource, and the configuration information associated with the UL subband frequency resource may indicate the start point of the UL subband as N_{ULSB}^{start}=72 and may indicate the size of a UL subband as N_{ULSB}^{size}=4. Accordingly, the UE may identify the end point of the UL subband as N_{ULSB}^{start}+N_{ULSB}^{size}=76. As described above, the UE may identify that a result obtained by performing a modulo operation on the start point of the UL subband and the PRB bundling size (i.e., N_{ULSB}^{start} mod P_{BWP,i}′) is 0, and may identify that a result obtained by performing a modulo operation on the end point of the UL subband and the PRB bundling size (i.e., (N_{ULSB}^{start}+N_{ULSB}^{size}) mod P_{BWP,i}′) is 0. Accordingly, the UE may determine that the configured UL subband is aligned with a PRG grid.

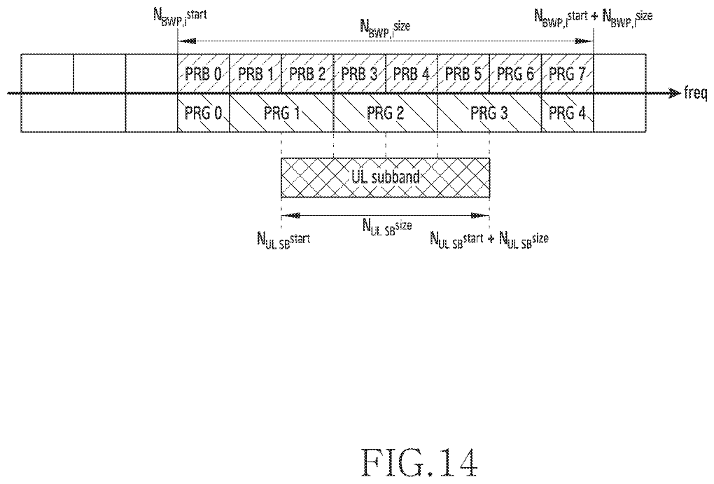

FIG. 14 illustrates a method of configuring a UL subband frequency resource that is not aligned with a PRG grid according to an embodiment.

Referring to FIG. 14, a UE may receive higher layer configuration information from a BS. Higher layer configuration information that the UE receives from the BS may include a DL BWP configuration, and for example, information for configurating a DL BWP may indicate the start point N_{BWP,i}^{start} of the BWP and the size N_{BWP,i}^{size} of the BWP in units of PRBs. In FIG. 14, the DL BWP configuration that the UE receives indicates N_{BWP,i}^{start}=71 and N_{BWP,i}^{size}=8, and the UE may identify the end point of the BWP as N_{BWP,i}^{start}+N_{BWP,i}^{size}=79. The UE may determine a PRG grid based on a PRB bundling size (e.g., PRB bundling granularity) configured based on the BWP configuration and higher layer configuration information received from the BS. In FIG. 14, it is assumed that a PRB bundling size is set to 2. In addition, the higher layer configuration information that the BS transmits to the UE may include configuration information associated with a UL subband frequency resource, and the configuration information associated with the UL subband frequency resource may indicate the start point of a UL subband as N_{ULSB}^{start}=73 and the size of the UL subband as N_{ULSB}^{size}=4. Accordingly, the UE may identify the end point of the UL subband as N_{ULSB}^{start}+N_{ULSB}^{size}=77. As described above, the UE may identify that a result obtained by performing a modulo operation on the start point of the UL subband and the PRB bundling size (i.e., N_{ULSB}^{start} mod N_{BWP,i}′) is not 0, and may identify that a result obtained by performing a modulo operation on the end point of the UL subband and the PRB bundling size (i.e., (N_{ULSB}^{start}+N_{ULSB}^{size})mod P_{BWP,i}′) is not 0. Accordingly, the UE may determine that the configured UL subband is not aligned with a PRG grid.

According to the method provided in the embodiment, although explicit signaling is not separately provided between the BS and the UE, the UE may determine whether a UL subband is aligned with a PRG grid. The BS may implicitly inform the UE of whether a UL subband is aligned with a PRG grid, without signaling overhead of transmitting separate information to the UE. Through the above, the burden of signaling overhead in the SBFD system may be reduced.

### Second Embodiment: A Method of Determining a PRG Size in Consideration of a UL Subband Frequency Resource

A UE may determine a PRG size in consideration of a result obtained by determining whether a UL subband frequency resource is aligned with a PRG grid based on configuration information received from a BS. The UE may receive a DL BWP, a PRB bundling size, and UL subband configuration information from the BS via higher layer signaling, and may determine whether the PRG grid and the UL subband are aligned based on the received configuration information. In this instance, with respect to one or more PRGs excluding the start point and the end point of a DL BWP, the UE may determine a PRG size based on whether the PRG grid and the UL subband frequency resource are aligned with each other.

[Method 2-1: A Method of Determining a PRG Size when a PRG Grid is not Aligned with a Ul Subband]

A UE may perform a modulo operation on a UL subband frequency resource and a PRB bundling size by using configuration information received from a BS, and may determine, based on a result obtained by performing the modulo operation, a PRG grid size at a point where a PRG grid and a UL subband are not aligned with each other. Specifically, the fact that the PRG grid and the UL subband frequency resource are not aligned may imply the following three cases.

In Case 1 where N_{ULSB}^{start} mod P_{BWP,i}′≠0, when a start point of a UL subband frequency resource is not aligned with a PRG grid.

In Case 2 where (N_{ULSB}^{Start}+N_{ULSB}^{size})mod P_{BWP,i}′≠0, when an end point of a UL subband frequency is not aligned with a PRG grid.

In Case 3 where Case 1 and Case 2 are satisfied, when both the start point and the end point of a UL subband frequency resource are not aligned with a PRG grid.

Based on a result obtained by performing a modulo operation using the frequency resource of a UL subband and PRB bundling size configuration information, the UE may determine a PRG size for each case mentioned above.

In Case 1, the UE may determine the size of a PRG to be N_{ULSB}^{start} mod P_{BWP,i}′ with respect to a predetermined PRG that is close to the start point of the UL subband. In Case 2, for a predetermined PRG that is close to the end point of the UL subband, the UE may determine the size of the corresponding PRG to be P_{BWP,i}′−(N_{ULSB}^{start}+N_{ULSB}^{size})mod P_{BWP,i}′. In Case 3, for a PRG that is close to the start point of the UL subband, the UE may determine the size of the corresponding PRG to be N_{ULSB}^{start} mod P_{BWP,i}′, and for a PRG close to the end point of the UL subband, the UE may determine the size of the corresponding PRG to be P_{BWP,i}′−(N_{ULSB}^{start}+N_{ULSB}^{size})mod P_{BWP,i}′. In this instance, a PRG size corresponding to a part remaining after excluding the start point and the end point of a DL BWP may be identical to a PRB bundling size (P_{BWP,i}′) configured via higher layer signaling.

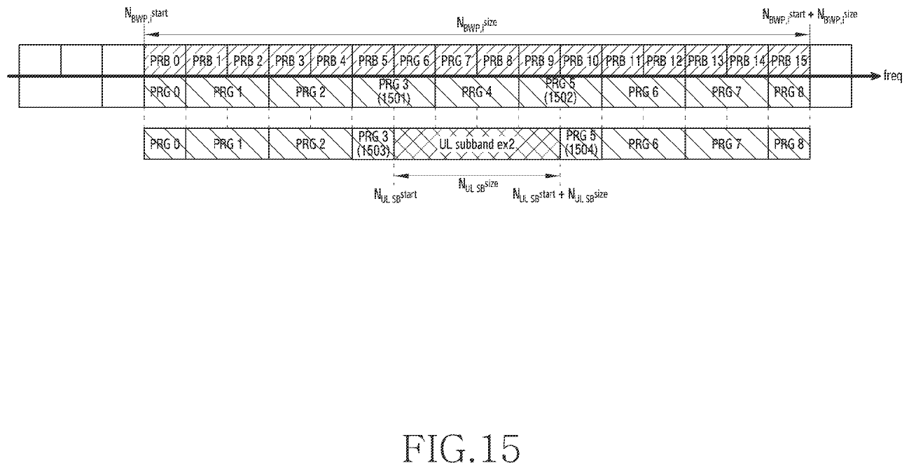

FIG. 15 illustrates a method of determining a PRG size according to an embodiment.

Referring to FIG. 15, a UE may receive higher layer configuration information from a BS, and DL BWP configuration information included in the higher layer configuration information may indicate the start point N_{BWP,i}^{start} of a BWP and the size N_{BWP,i}^{size} of the BWP in units of PRBs. In FIG. 15, the DL BWP configuration information that the BS transmits to the UE may indicate N_{BWP,i}^{start}=71 and N_{BWP,i}^{size}=16, and the UE may identify, based on the configuration information, that the end point of the BWP is N_{BWP,i}^{start}+N_{BWP,i}^{size}=87. A PRG grid may be determined based on a PRB bundling size (e.g., PRB bundling granularity) configured based on the above-described BWP configuration and higher layer configuration information. In FIG. 15, it is assumed that a PRB bundling size is set to 2. In addition, the UE may receive UL subband configuration information from the BS, and the UL subband configuration information may indicate the start point of the UL subband as N_{ULSB}^{start}=77 and may indicate the size as N_{ULSB}^{size}=4 in association with a UL subband frequency resource. Accordingly, the UE may identify the end point of the UL subband as N_{ULSB}^{start}+N_{ULSB}^{size}=81. The PRG size of the start point of the DL BWP may be determined to be P_{BWP,i}′−N_{BWP,i}^{start} mod P_{BWP,i}′=1, and the PRG size of the end point may be determined to be (N_{BWP,i}^{start}+N_{BWP,i}^{size})mod P_{BWP,i}′=1. The UE may determine a PRG grid by identifying P_{BWP,i}′=2 for other PRGs excluding a PRG at the start point of the DL BWP and a PRG at the end point.

FIG. 15 illustrates when the start point and the end point of a UL subband are not aligned with a PRG grid according to an embodiment. The example of FIG. 15 illustrates when the start point of a UL subband frequency resource is not aligned with a PRG grid, and the end point of the UL subband frequency resource is not aligned with the PRG grid either (Case 3 described in method 2-1). In FIG. 15, the UE may determine the sizes of two PRGs close to the UL subband, that is, the sizes of PRG 3 1501 and PRG 5 1502. Specifically, for PRG 3 1503 that is close to the start point of the UL subband, the UE may determine the size of PRG 3 1503 to be N_{ULSB}^{start} mod P_{BWP,i}′=1. In addition, for PRG 5 1504 that is close to the end point of the UL subband, the UE may determine the size of PRG 5 1504 to be P_{BWP,i}′−(N_{ULSB}^{start}+N_{ULSB}^{size})mod P_{BWP,i}′=1.

The BS may flexibly and efficiently configure a UL subband for a UE, and, particularly, may determine a PRG size in consideration of a UL subband even though the sizes of some PRGs are not explicitly and separately indicated to the UE. In addition, based on configuration information received from the BS, the UE may determine a PRG size in consideration of a UL subband and may be capable of determining a PRG size appropriate for an SBFD system.

Method 2-2: Determining a PRG Size when a PRG Grid is Aligned with a UL Subband

A UE may determine a PRG size based on a DL BWP, a PRB bundling size, and UL subband configuration information, which are received from a BS via higher layer signaling. According to the above-described embodiments, when the UE determines that both the start point and the end point of the frequency resource of a UL subband are aligned with a PRG grid, the UE may determine a PRG size without separate calculation. That is, for one or more PRGs excluding the start point and the end point of the DL BWP, the UE may determine each PRG size as a PRB bundling size (P_{BWP,i}′).

Method 2-3: A BS Configures Only a UL Subband Frequency Resource Aligned with a PRG Grid

When a UE receives UL subband configuration information from a BS, the UE may assume that the frequency resource of a UL subband identified based on the received configuration information is always aligned with a PRG grid. In other words, the UE may not expect the BS to configure a UL subband in a manner that the start point or the end point of a UL subband frequency resource is not aligned with the PRG grid. Unlike the above-described method 2-1 or method 2-2, according to method 2-3, the frequency resource of the UL subband determined according to the UL subband configuration information transmitted from the BS to the UE is always aligned with the PRG grid, the UE may determine a PRG size based on a DL BWP and a PRB bundling size which are received from the BS via higher layer signaling. That is, for a PRG excluding the start point and the end point of the DL BWP, a PRG size may be determined to be a PRB bundling size (P_{BWP,i}′).

### Third Embodiment: Interpreting the Size of a Scheduled PRB

The third embodiment provides a method in which a UE interprets the size (N_{RB}) of a scheduled PRB to receive a PDSCH in an SBFD symbol/slot. A BS may transmit PDSCH related configuration information to the UE via higher layer signaling. In an SBFD system, it is assumed that the PDSCH transmission is performed only in an SBFD symbol/slot, it is assumed that the PDSCH transmission is performed only in a DL only symbol/slot, or it is assumed that the PDSCH transmission is performed in both the DL only symbol/slot and the SBFD symbol/slot. To allow PDSCH transmission only in a predetermined symbol/slot (DL only symbol/slot or SBFD symbol/slot) may limit the time resource of DL scheduling of the BS, and thus the overall system performance may deteriorate. Therefore, to secure flexibility in PDSCH scheduling of the BS in the SBFD system, transmission needs to be performed in both the DL only symbol/slot and the SBFD symbol/slot, which may be efficient from the perspective of system performance.

When a PDSCH is transmitted in both the DL only symbol/slot and SBFD symbol/slot, the UE needs a method of accurately interpreting a PRB size scheduled by the BS. For example, when configuration information that the UE receives from the BS includes information that requires to be calculated based on the size of a scheduled PRB such as a PTRS frequency density or a PRB bundling size, the UE may need to clearly define whether to use the size of a PRB scheduled in a DL only symbol/slot to interpret the information, or to use a PRB size excluding a UL subband frequency resource from an SBFD symbol/slot to interpret the information. For example, the BS may transmit information indicating dynamicBundling as a PRB bundling type to the UE via higher layer signaling. In this instance, a PRB bundling size may be determined based on DCI indication information and a condition of configuration information (whether consecutive PRBs are scheduled and the size of a scheduled PRB) which are obtained from the BS. Therefore, there is a need for a reference for interpreting the size of a scheduled PRB appropriate for an SBFD symbol/slot. In addition, in relation to a PTRS frequency density, granularity in the frequency resource area may be determined based on the size of a scheduled PRB. For example, when a PRB size is scheduled to be higher than a predetermined value, a PTRS frequency density may be mapped at intervals of 4 RBs. In this instance, the PTRS frequency density may be appropriate for a DL only symbol/slot but the corresponding PTRS frequency density may be inappropriate for an SBFD symbol/slot where a frequency resource area is small.

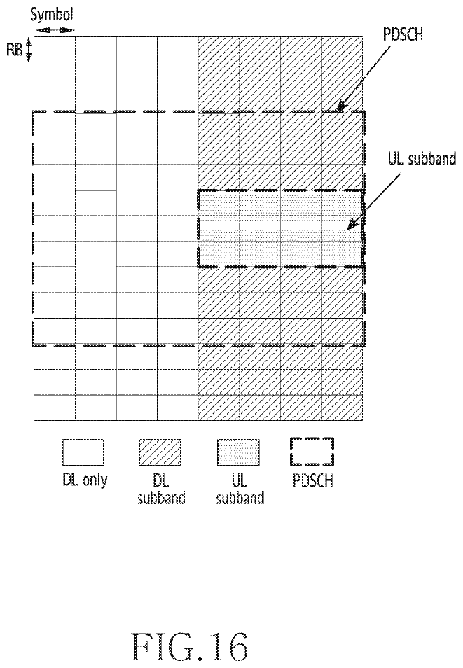

FIG. 16 illustrates a PDSCH configuration scheduled in an SBFD system according to an embodiment.

Referring to FIG. 16, a symbol/slot for DL reception in an SBFD system may be a DL only symbol/slot or a DL subband symbol/slot (i.e., a DL resource in an SBFD slot/symbol). In association with a frequency resource of a PDSCH that a BS schedules for a UE, the start point and the end point of a PRB may be clear in a DL only symbol/slot. In an SBFD symbol/slot, when a scheduled PRB is located in both a DL subband and a UL subband, it may be ambiguous whether the UE needs to interpret the size of a scheduled PRB to be the same as that of the DL only symbol/slot, or whether the UE needs to interpret the size of a scheduled PRB to be a PRB size of the frequency resource (i.e., a DL subband) remaining after excluding a UL subband frequency resource from the PDSCH frequency resource. To overcome the drawback, the UE may interpret the size of a scheduled PRB by using at least one of the scheduled PRB size interpret methods as follows.

Method 3-1: In an SBFD symbol/slot, a UE may interpret the size of a scheduled PRB to be the size of a PRB excluding a UL subband from a PDSCH frequency resource and may receive a PDSCH. In other words, the UE may interpret a PRB size of a scheduled PDSCH frequency resource to be the number of PRBs located in a DL subband in an SBFD symbol/slot, and may receive a PDSCH. Based on scheduling information that the UE receives from the BS, it is assumed that the size of the scheduled PDSCH frequency resource is N_{RB,PDSCH} and the size of the frequency resource of the UL subband is N_{RB,UL subband}. Based on the configuration information, the UE may interpret the size of a scheduled PRB in the SBFD symbol/slot to be N_{RB}=N_{RB,PDSCH}−N_{RB,UL subband}. Based on the interpreted scheduled PRB size, the UE may perform operations such as determining a PRB bundling size and/or interpreting a PTRS frequency density or the like.

According to method 3-1 mentioned above, the UE may determine a PRB bunding size in consideration only a DL subband that is a resource appropriate for PDSCH reception in an SBFD system, and may determine a PTRS frequency density.

Method 3-2: In an SBFD symbol/slot, a UE may interpret the size of a scheduled PRB to be the size of a PRB configured as a PDSCH frequency resource and may receive a PDSCH. In other words, the UE may interpret the size of a PRB of the scheduled PDSCH frequency resource to be the number of PRBs as they are without taking into consideration a UL subband and a DL subband in the SBFD symbol/slot, and may receive a PDSCH. According to the scheduling information that the UE receives from a BS, it is assumed that the size of the scheduled PDSCH frequency resource is N_{RB,PDSCH}. According to method 3-2, the UE may interpret the size of a scheduled PRB in the SBFD symbol/slot to be N_{RB}=N_{RB,PDSCH}. That is, the UE may interpret the size of a PRB configured as a PDSCH frequency resource to be a scheduled PRB, irrespective of the size of a UL subband. Based on the interpreted scheduled PRB size, the UE may perform operations such as determining a PRB bundling size and/or interpreting a PTRS frequency density or the like.

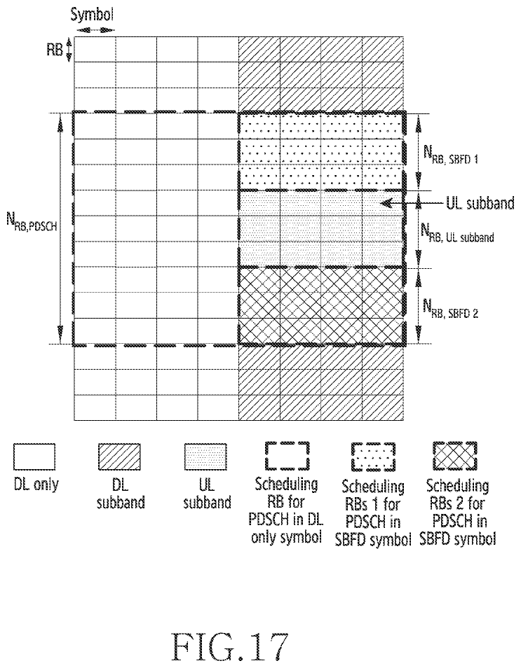

FIG. 17 illustrates a method of interpreting the size of a scheduled PRB in an SBFD symbol/slot according to an embodiment.

In FIG. 17, according to method 3-1 mentioned above, a UE may interpret the size of a scheduled PRB in an SBFD symbol/slot to be N_{RB,PDSCH}−N_{RB,UL subband} (or N_{RB,SBFD1}+N_{RB,SBFD2}) and may receive a scheduled PDSCH. According to method 3-2 described above, the UE may interpret the size of a scheduled PRB in an SBFD symbol/slot to be N_{RB,PDSCH}, and may receive a scheduled PDSCH.

### Fourth Embodiment: A Method of Interpreting DL and UL BWPs

The fourth embodiment provides a description associated with a method in which a UE interprets the size (N_{BWP,i}^{size}) of a DL BWP to receive a PDSCH in an SBFD symbol/slot. As described in the third embodiment, for flexible scheduling in an SBFD system, there is a need to allow data transmission in both a DL only symbol/slot and an SBFD symbol/slot. For example, when dynamicBundling is configured for the UE by a BS as a PRB bundling configuration in a PDSCH configuration, it is ambiguous to interpret the size of a BWP in an SBFD system. Therefore, hereinafter, there is provided a method of interpreting the size of a configured BWP when a UE interprets configuration information configured by a BS or performs operation.

Method 4-1: In an SBFD symbol/slot, a UE interprets the size of a BWP to be a frequency resource excluding a UL subband from a configured DL BWP, and may perform operations in the DL BWP. For example, based on configuration information received from a BS, the UE may identify that the size of the DL BWP is N_{BWP,i}^{size} and may identify that the frequency resource size of the UL subband is N_{RB,UL subband}. Based on the configuration information, the UE may interpret the size of the DL BWP in an SBFD symbol/slot to be N_{BWP,i,SBFD}^{size}=N_{BWP,i}^{size}−N_{RB,UL subband}, and may perform operation in the DL BWP. Based on the interpreted BWP size, the UE may perform operations such as determining of a PRB bundling size in the DL BWP, or the like.

Method 4-2: In an SBFD symbol/slot, a UE may interpret the size of a BWP to be the same as that of a configured DL BWP, and may perform operations in the DL BWP. For example, based on configuration information received from a BS, the UE may identify that the size of the DL BWP is N_{BWP,i}^{size} and may identify that the frequency resource size of the UL subband is N_{RB,UL subband}. Based on the configuration information, the UE may interpret the size of the DL BWP in the SBFD symbol/slot to be N_{BWP,i,SBFD}^{size}=N_{BWP,i}^{size}, and may perform operation in the DL BWP. Based on the interpreted BWP size, the UE may perform operations such as determining of a PRB bundling size in the DL BWP, or the like.

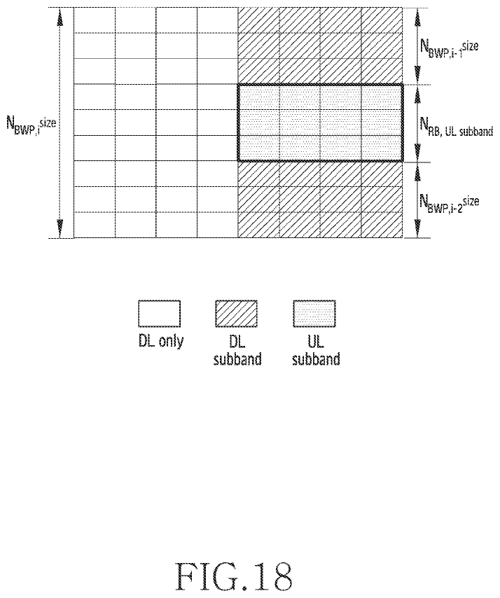

The content related to method 4-1 and method 4-2 will be described in detail with reference to the example of FIG. 18. FIG. 18 illustrates a method of interpreting a DL BWP in an SBFD symbol/slot according to an embodiment.

In FIG. 18, according to method 4-1, a UE may interpret the size of a DL BWP in an SBFD symbol/slot to be N_{BWP,i}^{size}−N_{RB,UL subband}, and may perform operation in the DL BWP. According to method 4-2, the UE may interpret the size of a scheduled PRB in the SBFD symbol/slot to be N_{BWP,i}^{size}, and may perform operation in the DL BWP.

### Fifth Embodiment: Interpreting Precoding of Wideband Bundling when Configuring PRB Bundling

In the fifth embodiment, there is provided a method of interpreting precoding when wideband PRB bundling is configured in an SBFD symbol/slot. A BS may include PRB bundling configuration information in PDSCH configuration information that the BS transmits to a UE. When the PDSCH configuration information that the UE receives from the BS includes configuration information indicating a wideband as a PRB bundling configuration, the UE may assume the same precoding for a configured PDSCH frequency resource. When a PDSCH frequency resource in the SBFD symbol/slot is a frequency resource area excluding a UL subband, a method of assuming precoding is provided as follows, to improve the channel estimation performance of the UE.

Method 5-1: Based on scheduling information received from a BS, a UE may assume that different precoding may be applied for each of the frequency resources which are separated by a UL subband in a scheduled PDSCH frequency resource area. In a description with reference to FIG. 17, a PDSCH frequency resource area in an SBFD symbol/slot may be separated into N_{RB,SBFD1} and N_{RB,SBFD2} by a UL subband. In this instance, the UE may assume that precoding 1 is applied to area N_{RB,SBFD1}, and precoding 2 is applied to N_{RB,SBFD2}, and may receive a PDSCH (precoding 1 and precoding 2 imply that different types of precoding are applied). According to method 5-1, different precoding is applied for each frequency domain, and thus the UE may expect that a channel estimation performance associated with DL data is improved.

Method 5-2: Based on scheduling information received from a BS, a UE may assume that the same precoding is applied in the entire frequency domain, without taking into consideration a frequency resource separated into parts due to a UL subband in a scheduled PDSCH frequency resource area (i.e., irrespective of whether a UL subband is present). In a description with reference to FIG. 17, although, in an SBFD symbol/slot, a PDSCH frequency resource area is an area excluding a part corresponding to a UL subband due to the UL subband, the UE may assume that the same precoding is applied to N_{RB,SBFD1} and N_{RB,SBFD2}, and may receive a PDSCH.

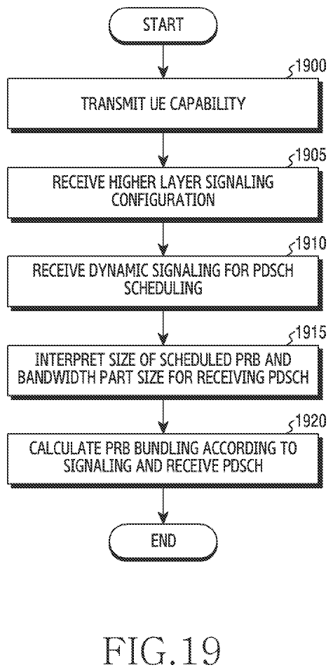

FIG. 19 illustrates an operation of a UE according to an embodiment.

A UE may transmit information associated with UE capability (or capability or ability) to a BS in operation 1900. The UE may receive configuration information produced with reference to the UE capability from the BS via higher layer signaling in operation 1905. The UE may receive, from the BS via dynamic signaling (e.g., DCI), scheduling information needed for receiving a PDSCH in operation 1910. Based on the configuration information received via higher layer signal and scheduling information received via dynamic signaling, the UE may apply one or more of the methods proposed in the first to fifth embodiments. For example, according to at least one of the third embodiment and the fourth embodiment, the UE may interpret the size of a scheduled PRB and a BWP size appropriate for a corresponding symbol/slot by using DL BWP configuration information, UL subband configuration information, and PDSCH scheduling information in operation 1915. As another example, according to the first embodiment, the second embodiment, and the fifth embodiment, the UE may determine whether UL subband is aligned with a PRG grid, and may determine and apply an appropriate PRG size (a PRB bundling size) based on whether the alignment is performed in operation 1915. Subsequently, the UE may receive a PDSCH from the BS according to a result of the operation performed in advance, in operation 1920.

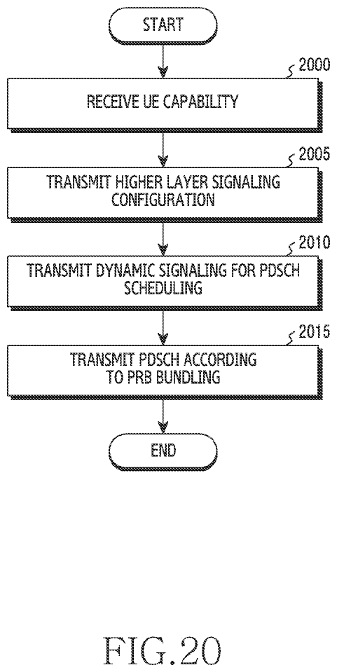

FIG. 20 illustrates an operation of a BS according to an embodiment.

A BS may receive information associated with UE capability (or capability or ability) from a UE in operation 2000. The BS may produce configuration information that refers to the received UE capability, and may transmit the configuration information to the UE via higher layer signaling in operation 2005. Subsequently, the BS may transmit, to the UE, scheduling information needed for PDSCH transmission via dynamic signaling (e.g., DCI) in operation 2010, and the BS may transmit a PDSCH to the UE in operation 2015 according to the methods proposed in the above-described first embodiment, second embodiment, and fifth embodiment.

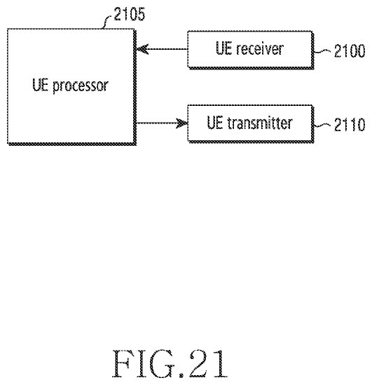

FIG. 21 illustrates a UE in a wireless communication system according to an embodiment.

Referring to FIG. 21, a UE may include a transceiver that is a collective name of a UE receiver 2100 and a UE transceiver 2110, a memory, and a UE processor 2105 (or a UE controller or processor). According to the above-described communication method of the UE, the transceiver 2100 and 2110, the memory, and the UE processor 2105 may operate. However, the component elements of the UE are not limited to the above-descried example. For example, the UE may include fewer or more component elements than the above-described component elements. In addition, the transceiver, the memory, and the processor may be embodied as a single chip.

The transceiver may perform signal transmission or reception with a BS. A signal may include control information and data. To this end, the transceiver may include an RF transmitter that up-converts and amplifies a frequency of a transmitted signal, an RF receiver that low-noise amplifies a received signal and down-converts a frequency, and the like. This is merely an example of the transceiver, and the component elements of the transceiver are not limited to an RF transmitter and an RF receiver.

In addition, the transceiver may receive a signal via a wireless channel and may output the same to the processor, and may transmit a signal output from the processor via a wireless channel.

The memory may store a program and data needed when the UE operates. In addition, the memory may store control information or data included in a signal transmitted or received by the UE. The memory may be embodied as a storage medium such as a ROM, a RAM, a hard disk, a CD-ROM, a DVD, and the like, or a combination of storage media. In addition, multiple memories may be used.

The processor may control a series of processes so that the UE operates according to the above-described embodiment of the disclosure. For example, the processor may receive DCIs configured in two types of layers, and may control component elements of a UE so as to receive multiple PDSCHs in parallel. Multiple processors may be used, and a processor may implement a program stored in a memory so as to control component elements of the UE.

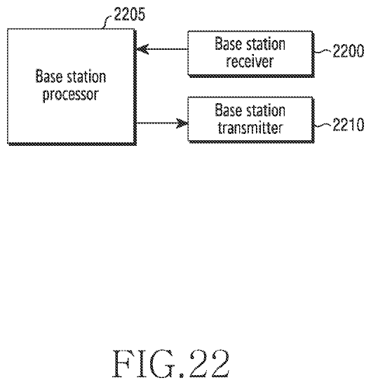

FIG. 22 illustrates a BS in a wireless communication system according to an embodiment.

Referring to FIG. 22, a BS may include a transceiver that is a collective name of a BS receiver 2210 and a BS transmitter 2210, a memory, and a BS processor 2205 (or a BS controller or processor). According to the above-described communication method of the BS, the transceiver 2200 and 2210 of the BS, the memory, and the BS processor 2205 may operate. However, the component elements of the BS are not limited to the above-descried example. For example, the BS may include fewer or more component elements than the above-described component elements. In addition, the transceiver, the memory, and the processor may be embodied as a single chip.

The transceiver may perform signal transmission or reception with a UE. To this end, the transceiver may include an RF transmitter that up-converts and amplifies a frequency of a transmitted signal, an RF receiver that low-noise amplifies a received signal and down-converts a frequency, and the like. However, this is merely one embodiment, and the component elements of the transceiver are not limited to the RF transmitter and the RF receiver.

In addition, the transceiver may receive a signal via a wireless channel and may output the same to the processor, and may transmit a signal output from the processor via a wireless channel.

The memory may store a program and data needed when the BS operates. In addition, the memory may store control information or data included in a signal transmitted or received by the BS. The memory may be embodied as a storage medium such as a ROM, a RAM, a hard disk, a CD-ROM, a DVD, and the like, or a combination of storage media. In addition, multiple memories may be used.

The processor may control a series of processes such that the BS operates according to the above-described embodiment of the disclosure. For example, the processor may control each component element of the BS to configure DCIs in two types of layers that include allocation information associated with multiple PDSCHs and to transmit the same. Multiple processors may be used, and a processor may implement a program stored in a memory so as to control component elements of the BS.

The methods according to various embodiments described herein may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. A plurality of such memories may be included in the electronic device.

In addition, the programs may be stored in an attachable storage device which may access the electronic device through communication networks such as the Internet, Intranet, local area network (LAN), Wide LAN (WLAN), and storage area network (SAN) or a combination thereof. Such a storage device may access the electronic device via an external port. A separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a BS and a terminal. As an example, a part of embodiment 1 of the disclosure may be combined with a part of embodiment 2 to operate a BS and a terminal. Furthermore, although the above embodiments have been described on the basis of the FDD LTE system, other variant embodiments based on the technical idea of the above-described embodiments may also be implemented in other systems such as TDD LTE, 5G, or NR systems.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) in a wireless communication system, the method comprising:
receiving, from a base station (BS), subband frequency information related to frequency domain resource allocation for an uplink (UL) subband;
receiving, from the BS, downlink control information (DCI) related to frequency domain resource allocation for a physical downlink shared channel (PDSCH);
identifying a precoding resource block group (PRG) including at least one physical resource block (PRB) for the PDSCH based on the subband frequency information and the DCI; and
receiving, from the BS, the PDSCH based on the PRG.

2. The method of claim 1, wherein the identifying the PRG includes:
determining whether a starting position of the UL subband is aligned with a boundary of the PRG or whether an ending position of the UL subband is aligned with a boundary of the PRG; and
modifying a size of the PRG to align with the starting position or the ending position of the UL subband based on the determination.

3. The method of claim 2, wherein the determining is performed by a calculation based on a number of the at least one PRB for the PDSCH.

4. The method of claim 1, further comprising:
identifying a number of scheduled PRBs for the PDSCH based on the subband frequency information; and
identifying the number of the at least one PRB based on the number of the scheduled PRBs for the PDSCH.

5. The method of claim 1, further comprising:
receiving, from the BS, information configuring a size of the PRG for the PDSCH; and
based on the information, applying a first precoding to a first part of the PDSCH and a second precoding to a second part of the PDSCH, wherein the first precoding and the second precoding are different.

6. A user equipment (UE) in a wireless communication system, the UE comprising:
a transceiver;
a controller coupled with the transceiver and configured to:
receive, from a base station (BS), subband frequency information related to frequency domain resource allocation for an uplink (UL) subband,
receive, from the BS, downlink control information (DCI) related to frequency domain resource allocation for a physical downlink shared channel (PDSCH),
identifying a precoding resource block group (PRG) including at least one physical resource block (PRB) for the PDSCH based on the subband frequency information and the DCI, and
receive, from the BS, the PDSCH based on the PRG.

7. The UE of claim 6, wherein the controller is further configured to:
determine whether a starting position of the UL subband is aligned with a boundary of the PRG or whether an ending position of the UL subband is aligned with a boundary of the PRG, and
modify a size of the PRG to align with the starting position or the ending position of the UL subband based on the determination.

8. The UE of claim 7,
wherein the determining is performed by a calculation based on a number of the at least one PRB for the PDSCH.

9. The UE of claim 6, wherein the controller is further configured to:
identify a number of scheduled PRBs for the PDSCH based on the subband frequency information, and
identify the number of the at least one PRB based on the number of the scheduled PRBs for the PDSCH.

10. The UE of claim 6, wherein the controller is further configured to:
receive, from the BS, information configuring a size of the PRG for the PDSCH, and
based on the information, apply a first precoding to a first part of the PDSCH and a second precoding to a second part of the PDSCH,
wherein the first precoding is different from the second precoding.

11. A method performed by a base station (BS) in a wireless communication system, the method comprising:
transmitting, to a user equipment (UE), subband frequency information related to frequency domain resource allocation for an uplink (UL) subband;
transmitting, to the UE, downlink control information (DCI) related to frequency domain resource allocation for a physical downlink shared channel (PDSCH); and
transmitting, to the UE, the PDSCH;
wherein the subband frequency information and the DCI are used for identifying a precoding resource block group (PRG) including at least one physical resource block (PRB) for the PDSCH.

12. The method of claim 11, wherein the identifying the PRG includes:
determining whether a starting position of the UL subband is aligned with a boundary of the PRG or whether an ending position of the UL subband is aligned with a boundary of the PRG; and
modifying a size of the PRG to align with the starting position or the ending position of the UL subband based on the determination.

13. The method of claim 12, wherein the determining is performed by a calculation based on a number of the at least one PRB for the PDSCH.

14. The method of claim 11, wherein the subband frequency information is used for identifying a number of scheduled PRBs for the PDSCH, and
wherein the number of the scheduled PRBs for the PDSCH is used for identifying the number of the at least one PRB.

15. The method of claim 11, further comprising:
applying a first precoding to a first part of the PDSCH and a second precoding to a second part of the PDSCH, wherein the first precoding is different from the second precoding; and
transmitting, to the UE, information configuring a size of a PRG,
wherein the information indicates a type of the applying.

16. A base station (BS) in a wireless communication system, the BS comprising:
a transceiver;
a controller coupled with the transceiver and configured to:
transmit, to a user equipment (UE), subband frequency information related to frequency domain resource allocation for an uplink (UL) subband,
transmit, to the UE, downlink control information (DCI) related to frequency domain resource allocation for a physical downlink shared channel (PDSCH), and
transmit, to the UE, the PDSCH,
wherein the subband frequency information and the DCI are used for identifying a precoding resource block group (PRG) including at least one physical resource block (PRB) for the PDSCH.

17. The BS of claim 16, wherein the identifying the PRG includes:
determining whether a starting position of the UL subband is aligned with a boundary of the PRG or whether an ending position of the UL subband is aligned with a boundary of the PRG; and
modifying a size of the PRG to align with the starting position or the ending position of the UL subband based on the determination.

18. The BS of claim 17, wherein the determining is performed by a calculation based on a number of the at least one PRB for the PDSCH.

19. The BS of claim 16, wherein the subband frequency information is used for identifying a number of scheduled PRBs for the PDSCH, and
wherein the number of the scheduled PRBs for the PDSCH is used for identifying the number of the at least one PRB.

20. The BS of claim 16, wherein the controller is further configured to:
apply a first precoding to a first part of the PDSCH and a second precoding to a second part of the PDSCH, wherein the first precoding is different from the second precoding, and
transmit, to the UE, information configuring a size of a PRG,
wherein the information indicates a type of the applying.
